(19) United States
(12) Patent Application Publication
(10) Pub. No.: US 2017/0311396 A1
(43) Pub. Date: Oct. 26, 2017

(54) Fluorescent Lamp Replacement LED Protection

(71) Applicant: InnoSys, Inc., Salt Lake City, UT (US)

(72) Inventor: Laurence P. SADWICK, Salt Lake City, UT (US)

(21) Appl. No.: 15/520,485

(22) PCT Filed: Oct. 31, 2014
(86) PCT No.: PCT/US2014/063596

§ 371 Date: Apr. 20, 2017

Related U.S. Application Data
(60) Provisional application No. 62/001,048, filed on May 20, 2014.
(60) Provisional application No. 61/908,074, filed on Dec. 20, 2013.
(60) Provisional application No. 61/898,357, filed on Oct. 31, 2013.

(51) Int. Cl. H05B 33/08; F21K 9/272; F21V 25/04; F21K 9/278; H05B 37/02; F21Y 2115/15; F21Y 2115/10

(52) U.S. Cl. CPC H05B 33/089; H05B 37/0272; H05B 33/0896; H05B 33/0845; H05B 33/0812; F21K 9/272; F21V 25/04; F21K 9/278; F21Y 2115/10; F21Y 2115/15

(57) ABSTRACT

A fluorescent lamp replacement may include one or more LED drivers and lamps in various embodiments, as well as a shock hazard/pin safety circuit. The present invention provides a fluorescent lamp replacement that, for example, powers an LED and/or OLED and/or QD lamp from a fluorescent fixture, including operating 5 and being powered by electronic ballasts. In some embodiments, a fluorescent lamp replacement includes a number of pins configured to electrically connect to a fluorescent lamp fixture, at least one non-fluorescent light source, a transistor between at least one of the pins and the at least one non-fluorescent light source, and a shock hazard protection circuit configured to disable the transistor to limit current flowing through at least some of the pins.

### BACKGROUND

Fluorescent lamps are widely used in a variety of applications, such as for general purpose lighting in commercial and residential locations, in backlights for liquid crystal displays in computers and televisions, etc. Conventional fluorescent tubes used for general lighting cannot, in general, be directly plugged into alternating current (AC) voltage lines. Fluorescent lamps generally include a glass tube, circle, spiral or other shaped bulb containing a gas at low pressure, such as argon, xenon, neon, or krypton, along with low pressure mercury vapor. A fluorescent coating is deposited on the inside of the lamp. As an electrical current is passed through the lamp, mercury atoms are excited and photons are released, most having frequencies in the ultraviolet spectrum. These photons are absorbed by the fluorescent coating, causing it to emit light at visible frequencies.

Electronic ballasts convert the input AC voltage supplied (typically at a low AC frequency of 50 or 60 Hz) power into generally a sinusoidal AC output waveform typically designed for a constant current output in the frequency range of above 20 to 40 kHz to typically less than 100 kHz and sometimes greater than 100 kHz.

Fluorescent lamps can suffer from a number of disadvantages, such as a relatively short life span, flickering, and noisy ballasts, etc. However there are many high quality electronic ballasts that are available. Although the ballasts may be of high quality and long life, often the florescent tubes that are powered by the ballasts, suffer from a number of undesirable effects including reduced lifetime due, for example, to being switched on and off too often. Therefore it would be desirable to have a replacement for fluorescent tubes that are not susceptible and immune from such effects or at least not so susceptible to these undesirable issues and effects. Furthermore, as replacements for fluorescent tubes are installed, the electrical contacts or pins at the ends of the tube replacements are exposed, which can carry dangerously high electrical currents.

### SUMMARY

The present invention provides a fluorescent lamp replacement that, for example, powers an LED and/or OLED and/or QD lamp from a fluorescent fixture, including operating and being powered by electronic ballasts.

In some embodiments, a fluorescent lamp replacement includes a number of pins configured to electrically connect to a fluorescent lamp fixture, at least one non-fluorescent light source, a transistor between at least one of the pins and the at least one non-fluorescent light source, and a shock hazard protection circuit configured to disable the transistor to limit current flowing through at least some of the pins. In some embodiments, the shock hazard protection circuit is a mechanical switch, which in some cases is normally closed, and in others is normally open. In some embodiments, the shock hazard protection circuit comprises an under-current detection circuit configured to detect a lower than expected current to the plurality of pins. In some cases, the shock hazard protection circuit comprises an optocoupler connected across a control input of the transistor and another lead of the transistor, or across a gate and a source of the transistor or other control voltage of the transistor, which is much lower than the voltage across the plurality of pins. In some cases, the shock hazard protection circuit is configured to short out a power source for the transistor.

In some embodiments, the fluorescent lamp replacement includes a ballast short circuit connected across the plurality of pins, and a fault detection circuit configured to control the ballast short circuit. In some cases, the fault detection circuit comprises an over-voltage detection circuit, over-current detection circuit, and/or over-temperature detection circuit. In some embodiments, the fault detection circuit is configured to short an AC current across the plurality of pins. Some embodiments include a diode connected between the transistor and the at least one non-fluorescent light source, and the fault detection circuit is configured to short a DC current between the transistor and the at least one non-fluorescent light source. Some embodiments include at least one capacitor connected in parallel with the at least one non-fluorescent light source downstream from the diode.

In some embodiments, the transistor comprises a common-gate, common-source, common-drain MOSFET pair.

Some embodiments include a constant-current regulation circuit. Some of these embodiments also include a processor having a remote control interface. The processor can be configured to transmit status information through the remote control interface, and/or to receive dimming commands through the remote control interface and to control the constant-current regulation circuit based at least in part on the dimming commands. In some of these instances, the shock hazard protection circuit is implemented at least in part by the processor.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE DRAWINGS

A further understanding of the various exemplary embodiments may be realized by reference to the figures which are described in remaining portions of the specification. In the figures, like reference numerals may be used throughout several drawings to refer to similar components. The words LED and LEDs are also used to describe and include OLED and OLEDs and QDs, or any other non-fluorescent light source.

FIG. 1 depicts a florescent lamp replacement (FLR).

FIG. 2 depicts a block diagram of an example embodiment of a fluorescent lamp fixture with ballast and a fluorescent lamp replacement.

FIG. 3 depicts a block diagram of an example embodiment of a fluorescent lamp ballast with two fluorescent lamp replacements.

FIG. 4 depicts a fluorescent lamp replacement with one of the connections to fluorescent lamp replacement connections connected to ground.

FIG. 5 depicts a fluorescent ballast with a connection to a florescent lamp replacement with one of the connections to fluorescent lamp replacement connections connected to ground.

FIG. 6 depicts a fluorescent ballast with a connection to a florescent lamp replacement with one or more of the connections to fluorescent lamp replacement connections connected to ground.

FIG. 7 depicts a fluorescent ballast with a connection to a florescent lamp replacement with one of the connections to fluorescent lamp replacement connections connected to ground.

FIG. 8 depicts a fluorescent ballast with a connection to a florescent lamp replacement with one of the connections to fluorescent lamp replacement connections connected via a human to ground.

FIG. 9 depicts a block diagram of an example embodiment of a fluorescent lamp LED replacement where the protection, or at least part of the protection, is after the rectification stage.

FIG. 10 depicts a block diagram of an example embodiment of a fluorescent lamp LED replacement with protection in which the protection or at least part of the protection is in front of the rectification stage.

FIG. 11 depicts a block diagram of an example embodiment of a fluorescent lamp LED replacement where the protection includes additional circuitry typically more than a switch and where the protection, or at least part of the protection, is after the rectification stage.

FIG. 12 depicts a block diagram of an example embodiment of a fluorescent lamp LED replacement where the protection includes additional circuitry typically more than a switch and where the protection, or at least part of the protection, is before the rectification stage.

FIG. 13 depicts a block diagram of an example embodiment of a fluorescent lamp LED replacement where various parts of the protection includes additional circuitry typically more than a switch and where the protection, or at least part of the protection, is both before and after the rectification stage.

FIG. 14 depicts a circuit diagram of an example embodiment of a fluorescent lamp LED replacement with hazard/leakage protection.

FIG. 15 depicts a circuit diagram of an example embodiment of a fluorescent lamp LED replacement having protection and detection that allows a periodic, short turn-on (hiccup mode).

FIG. 16 depicts a circuit diagram of an example embodiment of a fluorescent lamp LED replacement having protection and detection including over-voltage protection with a shunt regulator and associated feedback and control.

FIG. 17 depicts a circuit diagram of an example embodiment of a fluorescent lamp LED replacement with over-voltage protection.

FIG. 18 depicts an example embodiment that can be used to reduce, limit or effectively short out the output voltage of a ballast.

FIG. 19 depicts another example of an implementation of the present invention that can be used to reduce, limit or effectively short out the output voltage of the ballast in which a bidirectional switch can be used.

FIG. 20 depicts an example embodiment of the present invention for a fluorescent lamp LED replacement.

FIG. 21 depicts an example embodiment of one type of detection circuit for a fluorescent lamp LED replacement.

FIG. 22 depicts an example embodiment of a shock hazard control circuit for a fluorescent lamp LED replacement.

FIG. 23 depicts an example embodiment of an over voltage and over temperature protection for a fluorescent lamp LED replacement.

FIG. 24 depicts an example embodiment of a fluorescent lamp LED replacement with capacitors for EMI/EMC filter components.

FIG. 25 depicts a version of the present invention that implements and allows for current transformation and also allows for emulation of the heater/cathodes.

FIG. 26 depicts another implementation of the present invention in which a center tapped secondary is used such that only two diodes or synchronous transistors are needed to realize and attain full wave rectification.

FIG. 27 depicts a version of the present invention that allows for current limit and protection.

FIG. 28 depicts a version of the present invention that allows for current limit and protection.

FIG. 29 depicts another version of a detection circuit for a fluorescent lamp LED replacement that provides current limit and protections.

FIG. 30 depicts an example embodiment of one type of detection circuit for a fluorescent lamp LED replacement.

FIGS. 31A-C depict versions of the present invention illustrating physically split apart high frequency rectification components that also can provide current limit and protections.

FIG. 32 depicts a block diagram of a microcontroller with a variety of inputs and outputs configured to control shock hazard or pin safety protection in a fluorescent lamp replacement in accordance with some embodiments of the invention.

FIG. 33 depicts a block diagram of a microcontroller with a variety of inputs and outputs configured to control shock hazard or pin safety protection in a fluorescent lamp replacement, with bidirectional remote control in accordance with some embodiments of the invention.

FIG. 34 depicts a block diagram of a fluorescent lamp replacement circuit that can be used with shock hazard/pin safety protection.

FIG. 35 depicts a block diagram of a fluorescent lamp replacement circuit that can be used with shock hazard/pin safety protection, including dimming control.

FIG. 36 depicts a block diagram of a fluorescent lamp replacement circuit that can be used with shock hazard/pin safety protection, including bidirectional dimming control and status feedback.

FIG. 37 depicts a block diagram of an example embodiment of a fluorescent lamp LED replacement with hazard/leakage protection and with inductor-driven load output.

FIG. 38 depicts a block diagram of an example embodiment of a fluorescent lamp LED replacement with hazard/leakage protection and with transformer-driven load output.

FIG. 39 depicts an example embodiment of a shock hazard control circuit for a fluorescent lamp LED replacement.

FIG. 40 depicts an example embodiment of a ballast over-voltage protection and over-temperature protection circuit for a fluorescent lamp LED replacement.

FIG. 41 depicts an example ballast shorting circuit that can be controlled by an over-voltage, over-current, and/or over-temperature or other fault detection circuit in a fluorescent lamp LED replacement.

FIG. 42 depicts an example embodiment of a fluorescent lamp LED replacement with dual MOSFET switch for shock hazard protection.

FIGS. 43A-43E depict various views of an end cap for a fluorescent lamp LED replacement with spring-mounted pins for shock hazard protection.

FIGS. 44A-44D depict various views of an end cap for a fluorescent lamp LED replacement with slide-switch activated pins with shock hazard protection.

FIGS. 45A-45C depict various views of a rotating end cap for a fluorescent lamp LED replacement with rotation-activated pins with shock hazard protection.

### DESCRIPTION

Brief definitions of terms used throughout this document are given below. The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic. When referring to light emitting diodes (LEDs) it is to be understood that LED can refer to any type of LED, any color or colors of LED (including white and any type or color temperature of white, for example cool white, warm white, daylight white, etc. and 6000 k, 2700 k, etc., respectively) including any type of organic LED (OLED) and, similarly, to quantum dot (QD)-based lighting.

A fluorescent replacement is disclosed herein that may be used to power one or more LED or OLED or QD or combination of these lamps from an electric ballast typically in a fluorescent fixture. An LED driver typically only requires two inputs from the electronic ballast source, which are then rectified typically using a bridge rectifier. Other types of rectification can also be used with the present invention.

The present invention can also use heater emulation circuits that allow, for example, rapid start, programmable start, programmed start, pre-start, dimmable ballasts, etc. warm, and other similar types of ballasts to work with the present invention by providing sufficient stimuli in response to the heater/cathode leads and associated circuits in the these ballasts which could be either low frequency magnetic or high frequency electronic and still be compatible with instant-start, cold-start, low frequency (i.e., 50/60 Hz and 400 Hz) AC universal voltage and higher voltage range ballasts.

A circuit that dynamically adjusts such that the output current to a load such as an LED and/or OLED and/or a QD array is essentially kept constant by, for example, in some embodiments of the present invention shorting or shunting current from the ballast as needed to maintain the output current to a load such as a LED and/or OLED and/or a QD array essentially constant. In other embodiments and implementations a switching circuit that contains, for example, one or more each of inductors, diodes, switching elements such as a transistor switch which could, for example, form a buck, buck-boost, boost, boost-buck, fly back, forward converter, push-pull, SEPIC, Cuk, etc. Some embodiments of the present invention may use time constants as part of the circuit. Embodiments of the present invention include buck (or buck-boost, boost-buck, boost) inductors, diodes, switches, etc. along with associated EMI filters and protection circuits that can be used with AC lines and magnetic and electronic ballasts including instant (cold) start, rapid (hot or warm) start, programmed start, dimmable, pre-start, etc. ballasts. In some embodiments the FLR or FLRs that are powered by AC lines, magnetic or electronic ballasts can be remotely (e.g., wirelessly and/or wired) dimmed, controlled, monitored, etc.

In some embodiments, a circuit powers a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In other embodiments of the present invention the protection device/switch may be off unless commanded or controlled to be set on. In and for various embodiments of the present invention, the device/switch may be of any type or form or function and includes but is not limited to, semiconductor switches, vacuum tube switches, mechanical switches, relays, etc. This and other protection mechanisms disclosed herein can be applied to fluorescent lamp replacements such as, but not limited to, those disclosed in U.S. Pat. No. 8,502,454 to Sadwick, which is incorporated herein by reference for all purposes.

In some embodiments, an over voltage protection (OVP) circuit shunts/shorts or limits the ballast output and/or the output to the load such as an LED and/or OLED and/or QD array in the event that the output voltage exceeds a set value.

In some embodiments, an over-temperature protection (OTP) circuit shunts/shorts or limits the ballast output and/or the output to the load such as an LED and/or OLED and/or QD array in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention.

Embodiments of the present invention include, but are not limited to, having a rectification stage (such as, but not limited to) consisting of a single full wave rectification stage to provide power/current to the output load such as an LED and/or OLED output load and a rectification stage (such as, but not limited to) consisting of a single full wave rectification stage to provide power to, for example, the hazard protection circuit.

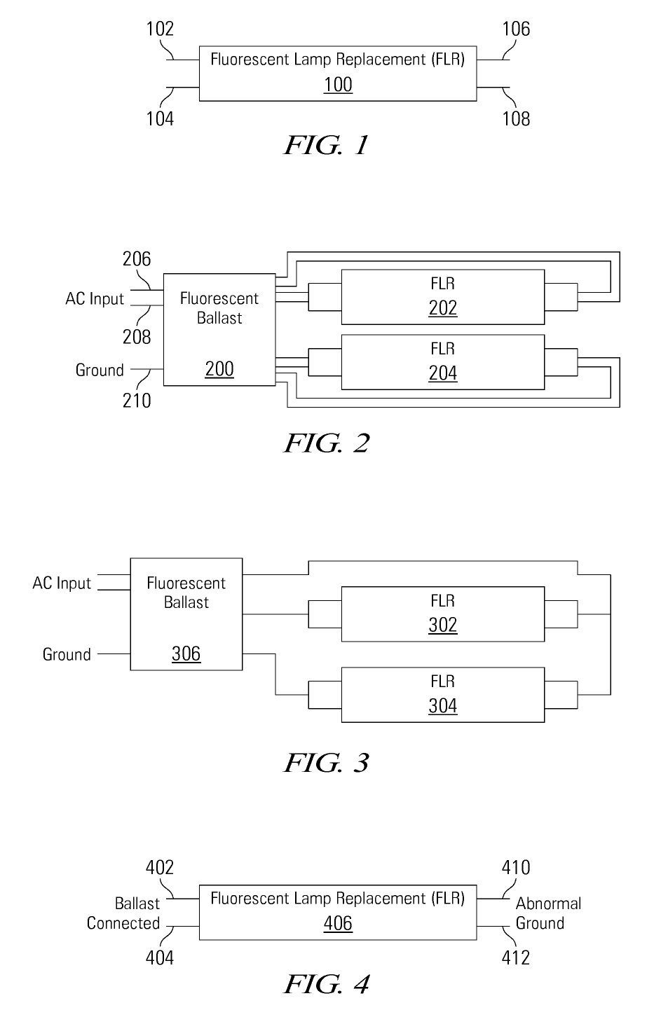

FIG. 1 shows an illustration of a florescent lamp replacement 100 (FLR) which may typically have up to four connections 102, 104, 106, 107 with two connections typically being the minimum needed. The FLR 100 in general consists of a rectification stage and some form of light source such as a light source made up of LEDs including organic light emitting diodes (OLEDs).

Turning now to FIG. 2, an example configuration of an electronic ballast 200 connected to two fluorescent lamp replacements 202, 204, in this case replacements for rapid start or program start fluorescent lamps, which include a heater. The ballast 200 is powered by an AC input 206, 208, and grounded by ground connection 210. Although two fluorescent lamp replacements 202, 204 are shown in FIG. 2, any number can be connected to a single ballast 200; in general up to N FLRs (i.e., 1 to N) can be connected to a single ballast 200 that is designed to support and power up to N florescent lamps. An example embodiment of a simple configuration places the ballast 200 in series with a bridge rectifier, which drives DC terminals (plus and minus, respectively) to the LED or OLED light source with or without optional capacitor(s).

Turning now to FIG. 3, an example embodiment of the present invention is shown with N=2 fluorescent lamp replacements 302, 304 attached to a single ballast 306. In this case, the fluorescent lamp replacements 302, 304 are adapted to replace instant start fluorescent lamps. More than one rectification unit such as a rectification full-bridge or a rectification synchronous full bridge or half-bridge may be used with the present invention. In addition, a transformer may also be used with the present invention to, for example, transform current and voltage from the output of the ballast to the rectification stage(s) connected either directly or indirectly to the LED or OLED lighting/lamps/arrays/etc.

Other embodiments of the present invention may use a second bridge rectifier or synchronous rectifier stage, or, for example, a total of 8 (or more or, in some cases, with shared diodes, greater than 4 and less than 8) discrete diodes to rectify the input. In general, the diodes should have a high frequency response in order to efficiently. The present invention provides a drop-in replacement(s) for fluorescent lamp(s). It also leaves the fixture unmodified, allowing the fixture to be used again at a later time for fluorescent lamps or to have people unskilled in electrical matters replace the fluorescent lamps with the FLRs. In particular, implementations and embodiments of the present invention allows for greater flexibility and potentially reduced EMI/EMC reducing potential EMI/EMC issues while also increasing the flexibility of the FLRs. Additional benefits of the present invention may be realized such as modularity and flexibility of design, construction, manufacturing, dimming, protection, safety, ease of use, non-skilled installation and replacement, etc. In addition, the present invention can, in general, be made to be an add-on feature to many existing AC to DC power supplies and, with proper adaptions and modifications, DC to DC power supplies. In addition, the present invention may be used and modified as needed with DC primary input power, constant current input power and can be optimized to operate over a wide range of input conditions, voltages and currents.

Turning now to FIG. 4, an example is shown where the FLR 406 may present a safety hazard or risk to people during installation such that one end/pins 402, 404 of the FLR 406 may come in contact with an abnormal ground while the other end/pins 410, 412 are connected to one lead/wire of the ballast thus permitting a current to flow between the output of the ballast and ground sufficient in many cases for there to be enough current to light, for example, the LEDs or OLEDs or QDs and also cause injury including fatal injury to a person or persons who may come in contact between the end/pin(s) 410, 412 of the FLR 406 that are not connected to the ballast wire(s)/lead(s)/output and ground—essentially in series with the right-side end 410, 412 of the FLR 406 and ground.

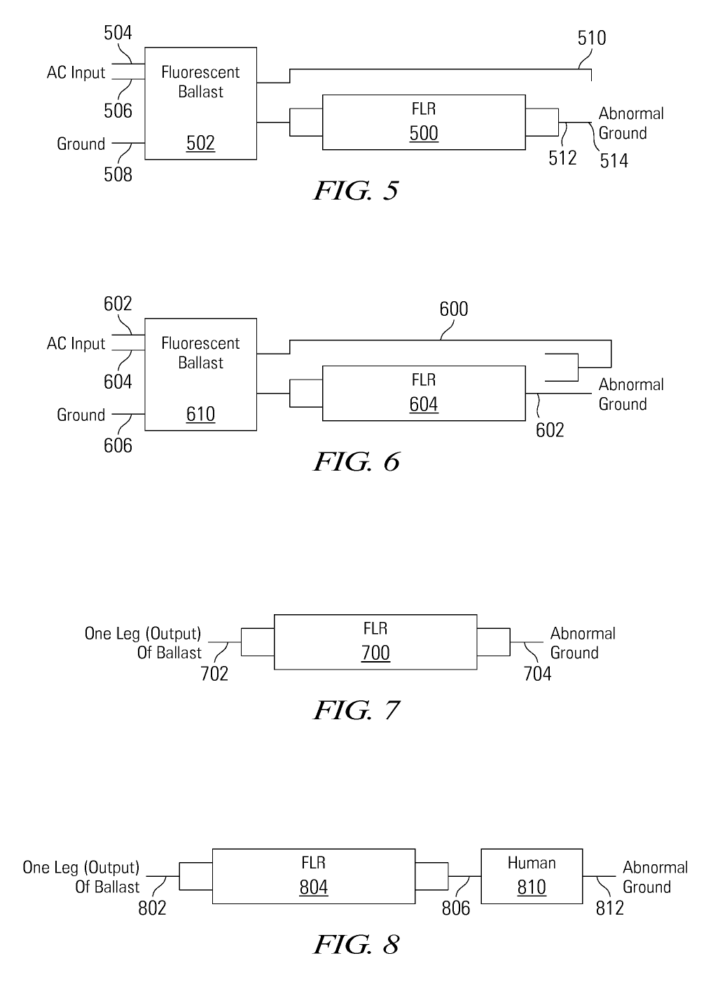

FIGS. 5 through 7 show other examples, illustrations and representations of potential hazard conditions and situations. In FIG. 5, a fluorescent lamp replacement 500 is connected to a ballast 502 at one end. The ballast 502 is powered by an AC input 504, 506, and grounded by ground connection 508. An electrical connection 510, typically housed safely within a fluorescent tube fixture, is intended to electrically connect to pin 512 on the fluorescent lamp replacement 502. As with other embodiments, the ballast 502 can be an instant start ballast as in FIG. 5, or a rapid start or program start ballast with additional heater connectors, or any other type of ballast. When the fluorescent lamp replacement 502 is fully connected within the fluorescent tube fixture, pin 512 is safely connected to electrical connection 510, protecting the user from electrical shock. However, when the fluorescent lamp replacement 502 is being installed, pin 512 can be exposed and, without protection mechanisms, can shock and injure a user contacting the pin 512 and appearing as an abnormal ground 514 through which an electrical current can flow. As shown in FIG. 6, the fixture 600 can have any number of configurations. While the exposed pin 602 of the fluorescent lamp replacement 604 is accessible, it is protected as disclosed herein to substantially or completely prevent current from flowing when connected to an abnormal ground, such as when a grounded user contacts the pin 602. As generalized in FIG. 7, the fluorescent lamp replacement 700 is not limited to use with any particular type of power source, ballast or fixture. As long as power is supplied to one pin 702 of the fluorescent lamp replacement 700, other pin(s) 704 should be protected as disclosed herein from inadvertent contact with an abnormal ground. This is illustrated explicitly in FIG. 8, in which one pin 802 of a fluorescent lamp replacement 804 is connected to a ballast or other power source, and another pin 806 is contacted by a person 810 who is grounded 812 or effectively may be in contact with ground 812. In the absence of a protection mechanism in the fluorescent lamp replacement 804, current would flow from the output of the ballast 802 through the fluorescent lamp replacement 804 and through the person 810 or living creature to ground. Such a current could be of sufficient level to cause harm, injury or even death to the human(s) or living creature/entity in between the end of the ballast and ground.

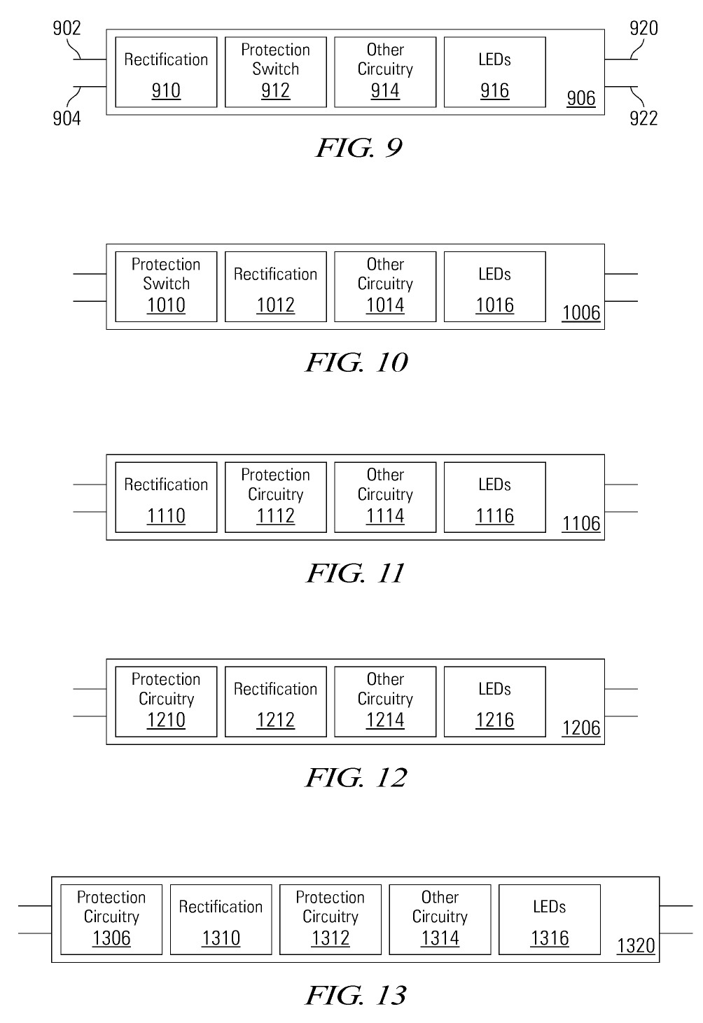

Turning to FIG. 9, a fluorescent lamp replacement 906 is depicted in accordance with some embodiments of the invention. The fluorescent lamp replacement 906 includes a rectification circuit 910, such as, but not limited to, a full or partial diode bridge to rectify an AC current at input pins 902, 904, one of which, in this example, is a rapid start heater connection. In other embodiments of the fluorescent lamp replacement 906 of FIG. 9, as well as variations of the fluorescent lamp replacements 1006, 1106, 1206, and 1320 of FIGS. 10-13, the fluorescent lamp replacements can be designed, for example but not limited to, to be connected to and/or powered by an instant start ballast, a rapid start, or other ballast or power source.

The fluorescent lamp replacement 906 includes a protection switch 912 following the rectification circuit 910, providing shock hazard protection against inadvertent contact with exposed pin(s) 920, 922. Such a protection switch 912 can be a switch such as a transistor of any type and form or any other type of switch such as a relay or other semiconductor device or devices with a suitable breakdown/hold-off/standoff/blocking/etc. voltage such that little or no (or an acceptable amount of current) can flow from the output of the ballast. Other circuitry 914 can be included to perform other desired functions such as over-voltage protection, over-current protection, constant current regulation and/or dimming circuitry, etc. Loads such as light emitting diodes 916 of one or more colors are powered by the current through rectification circuit 910.

FIG. 10 shows an example embodiment of a fluorescent lamp replacement 1006 including a protection circuit 1010 in which the protection or at least part of the protection is electrically in front of the rectification stage 1012. Such protection 1010 could consist of switch that allows current to flow in both directions (i.e., positive and negative directions from the output of the ballast to, for example, short out the output of the ballast or redirect the current from the output of the ballast. Other circuitry 1014 can be included in addition to light emitting diodes 1016.

FIG. 11 shows an example embodiment where the protection circuit 1112 in a fluorescent lamp replacement 1106 includes additional circuitry typically more than a switch and where the protection, or at least part of the protection, is after the rectification stage 1110. Such a protection circuit 1112 could consist of a switch such as a transistor of any type and form or any other type of switch with a suitable breakdown/hold-off/standoff/blocking/etc voltage and detection, monitoring and/or control circuitry for the switch such that little or no (or an acceptable amount of current) can flow from the output of the ballast. Other circuitry 1114 can be included in addition to light emitting diodes 1116.

FIG. 12 shows an example embodiment in which the protection circuit 1210 in a fluorescent lamp replacement 1206 includes additional circuitry typically more than a switch and where the protection circuit 1210, or at least part of the protection, is before the rectification stage 1212. Other circuitry 1214 can be included in addition to light emitting diodes 1216.

FIG. 13 shows an example embodiment where various parts of the protection circuit 1306, 1312 in a fluorescent lamp replacement 1320 includes additional circuitry typically more than a switch and where the protection circuit 1306, 1312, or at least part of the protection, is both before and after the rectification stage 1310. Other circuitry 1314 can be included in addition to light emitting diodes 1316.

The fluorescent lamp replacement protection of, for example, FIGS. 9 through 13 may be used with any suitable LED or OLED driver and/or LED or OLED lamp or other types of loads, and is not limited to any examples set forth herein. For example, the fluorescent lamp replacement of FIGS. 1 through 13 may be used with any of the embodiments described in U.S. patent application Ser. No. 12/422,258 entitled “Dimmable Power Supply”, filed Apr. 11, 2009, U.S. patent application Ser. No. 12,776/435 entitled “Universal Dimmer”, filed May 10, 2010, U.S. Patent Application 61/646,289 filed May 12, 2012 for a “Current Limiting LED Driver”, and in U.S. Pat. No. 8,148,907 issued Apr. 3, 2012 for a “Dimmable Power Supply”, the entirety of each of which is incorporated herein by reference for all purposes. The invention disclosed herein can also be used in connection with circuits and applications disclosed in the following, which are incorporated herein by reference for all purposes: U.S. Patent Application No. 61/776,671 entitled “Fluorescent Lamp LED Replacement” filed Mar. 11, 2013, U.S. Patent Application No. 61/786,047 entitled “Digital Dimmable Driver” filed Mar. 14, 2013, U.S. Patent Application No. 61/786,406 entitled “Powerline Control Interface” filed Mar. 15, 2013, U.S. Patent Application No. 61/786,415 entitled “Ripple Reducing LED Driver” filed Mar. 15, 2013, U.S. Patent Application No. 61/800,677 entitled “Linear LED Driver” filed Mar. 15, 2013, and U.S. Patent Application No. 61/800,837 entitled “Fluorescent Lamp LED Replacement” filed Mar. 15, 2013.

Other components may also be placed in series or parallel with the bridge rectifiers including an input fuse, in certain cases, a varistor, a spark gap, other transistors, etc. Alternatively, the diode bridge(s) could also be implemented with an appropriate number of individual diodes having the appropriate characteristics including high frequency diode performance.

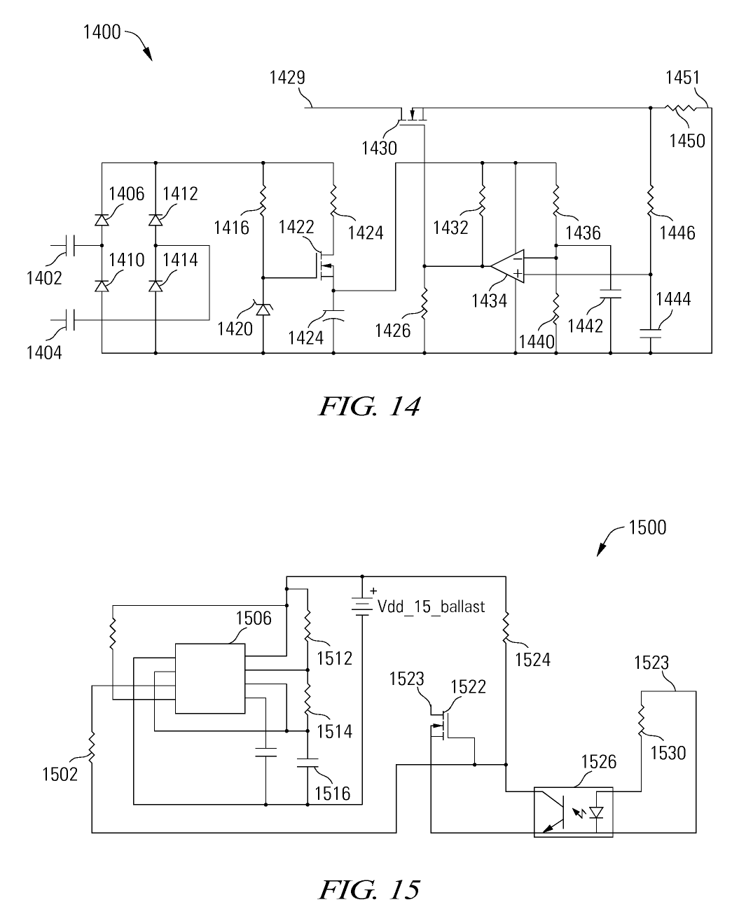

Turning now to FIG. 14, an embodiment of a fluorescent lamp LED replacement 1400 is depicted in which the hazard/leakage protection has a power supply source that consists of capacitors 1402, 1404 which perform AC coupling and current limiting, and of diodes 1406, 1410, 1412, 1414 which form a rectified floating power supply that is further regulated using the regulator consisting of resistors 1416, 1424, capacitor 1424, Zener diode 1420 and transistor 1422. A time constant can be included in the rectified floating power supply, for example, using resistor 1424 and capacitor 1424. Resistors 1436, 1440 form a voltage divider that acts as a reference set point which is filtered by optional capacitor 1442 that is fed to the inverting terminal of a comparator 1434 (or similar function such as an op amp) with the voltage from a sense resistor 1450 being fed to the non-inverting input of the comparator 1434 via an optional filter/time constant consisting of resistor 1446 and capacitor 1444 such that when the signal from the sense resistor 1450 is larger than the reference set point signal, the comparator 1434 goes high and turns on transistor 1430 which allows (not shown in FIG. 14) the output of the ballast (which is the input to the FLR) to flow through a rectification stage that may contain optional capacitors at the input (similar to the input stage consisting of capacitors 1402, 1404, diodes 1406, 1410, 1412, 1414) to the rest of the FLR including to the LED and/or OLED and/or QD load. Feedback resistors and pullup/pulldown resistors (e.g., 1432, 1426) can be included as needed or desired. Transistor/switch 1430 is in series with (and in between) the input rectification stage of the FLR connected to node 1429 and the LED (or OLED or QD) load of the FLR connected to node 1451. When the voltage across sense resistor 1450 is above the reference set point voltage, transistor 1430 is turned on and current/voltage is allowed to flow to the LED or OLED or QD load. If the current through the sense resistor 1430 produces too small of a voltage then transistor 1430 is turned off preventing current from flowing and thus limiting and preventing a hazard/shock/leakage current condition from occurring.

Additional circuitry not shown allows transistor 1430 to be initially turned on even when the current is well below the set point. Such additional circuitry can be accomplished in many ways including a simple RC time constant properly inserted and located such that it initially allows transistor 1430 to be turned on for a relatively short, momentary amount of time so as to allow current to flow and achieve normal operating conditions if the FLR is connected to the ballast correctly.

If the FLR is not connected to the ballast correctly (examples of such shown in FIGS. 5 through 8) then a lower current will in general be obtained resulting in the hazard protection circuitry turning off transistor 1430 and essentially eliminating or substantially reducing the hazard/leakage current and threat of harm and injury to people and other living creatures. Various embodiments and implementations of the protection circuitry allow for diverse possible responses to the detection of the fault hazard condition including, but certainly not limited to, a complete turn-off (i.e., latch off) until power is cycled (i.e., turned off and then turned back on) or, as another example, periodically turned back on for a brief moment to see if the hazard fault condition had cleared (i.e., the FLR had been correctly plugged into the ballast).

Such a periodic, short turn-on (hiccup mode) can be accomplished by a number of means and methods including, but not limited to, the example circuit 1500 shown in FIG. 15 where the integrated timer circuit 1506 and resistors 1512, 1514, and capacitor 1516 form a timing sequence that periodically sends a pulse through resistor 1502 to periodically pull transistor 1522 low to allow the transistor 1430 in FIG. 14 to be turned on. (Note, in this embodiment, the comparator 1434 and associated components in the right side of FIG. 14 are replaced with the timer circuit 1506 and associated resistors and capacitor of the left side of FIG. 15. In addition, a second circuit consisting of resistor 1524, optocoupler 1526 and resistor 1530 can be used that allow an isolated control and turn-off of transistor 1522 in FIG. 15. By applying a sufficient signal to the input of the optocoupler 1526 at node 1523, transistor 1522 is turned off, thus allowing transistor 1434 in FIG. 14 to turn on and permit current to flow to the LED or OLED load should a fault condition not exist permitting an autostart/hiccup mode of operation to take place should a fault condition occur. The circuit 1500 of FIG. 15 can be applied to that of FIG. 14 by connecting the drain 1523 of transistor 1522 to the gate of transistor 1430 of FIG. 14.

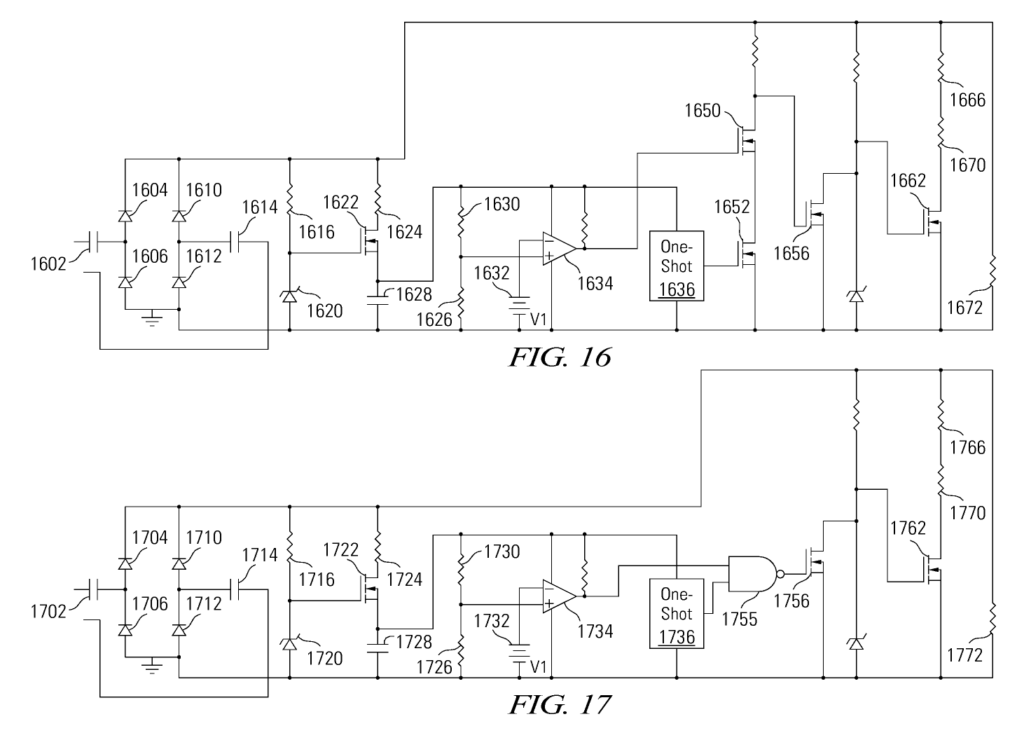

FIG. 16 shows an example over-voltage protection (OVP) embodiment of the present invention. As shown in FIG. 16, the over-voltage protection circuit has an optional power supply source that consists of AC coupling and current limiting capacitors 1602, 1614 (which can have resistors connected in parallel to provide a DC path), and diodes 1604, 1606, 1610, 1612 which form a rectified floating power supply that is further regulated using the regulator consisting of resistors 1616, 1624, capacitor 1628, Zener diode 1620 and transistor 1622. Optional resistors (not shown) can be connected in parallel with AC coupling capacitors 1602, 1614 if desired to provide a DC path, in embodiments in which the ballast connected to AC coupling capacitors 1602, 1614 checks for a DC path before enabling normal operation.

Resistors 1630, 1626 form a voltage divider that acts as a reference set point which can also be filtered by, for example, a capacitor (not shown). The resulting reference set point is fed to the non-inverting terminal of a comparator 1634 (or similar function such as an op amp) with the voltage from a sense resistor (represented by a voltage V1 1632 in FIG. 16) being fed to the inverting input of the comparator 1634 via an optional filter/time constant (not shown). When the signal from the sense resistor, represented by voltage V1 1632, is larger than the reference set point signal, the comparator 1634 goes low and turns off transistor 1650 which, in turn, turns on transistor 1656 and turns off transistor 1662, which acts as the over-voltage protection (OVP) transistor, shunting the current through optional resistors 1666, 1670 (which in many embodiments can be shorted) of the rectified ballast output. In the event that the current sensed is too small, then the comparator output goes high which turns on transistor 1650 and turns off transistor 1656 (assuming that transistor 1652 is also turned on) which allows the OVP transistor 1662 to be turned on and therefore the current to be shunted through transistor 1662.

An optional one-shot circuit 1636, or timer circuit, monostable multivibrator, pulse generator, etc. and associated transistor 1652 act so as to provide an example mechanism to periodically turn on the auto-restart/hiccup mode such that in the event OVP is triggered, the optional one-shot circuit 1636 which drives transistor 1652 can be set to periodically turn off allowing transistor 1656 to be turned on and thus turning off transistor 1662. Resistor 1672 represents the rest of the FLR including the LED (or OLED) load. Removing the optional example one-shot circuit 1636 and transistor 1652 can in some cases result in a potentially latched OVP circuit.

Other embodiments of the present invention reverse the input to the comparator 1634 with the reference connected to the inverting input of the comparator and a voltage divider attached to the output of the diode bridge shown in FIG. 16 (which could be replaced by a synchronous transistor bridge) with the center of the voltage divider connected to the non-inverting input of the comparator 1634 such that when an over-voltage condition exists, the comparator 1634 goes high and turns on transistor 1650 which turns off transistor 1656 allowing the over-voltage transistor 1662 to be turned on resulting in the current being shunted through transistor 1662. In this case the optional one-shot circuit 1636 and associated transistor 1652 are connected in an OR configuration with/in some embodiments of the present invention having a timer circuit with some additional components including diode(s), resistor(s), capacitor(s), transistors, etc. In general, embodiments of the present invention can use AND, OR, NAND, NOR, and/or other types of Boolean Algebra operations and operations to accomplish various types of functions including but not limited to the optional hiccup mode, OVP, OTP, shock hazard, etc.

Turning now to FIG. 17, an example embodiment of the OVP is shown in which a NAND two input gate 1755 is explicitly shown. In this particular embodiment, the over-voltage protection has an optional power supply source that consists of AC coupling and current limiting capacitors 1702, 1714 (which can have resistors connected in parallel to provide a DC path), and diodes 1704, 1706, 1710, 1712 which form a rectified floating power supply that is further regulated using the regulator consisting of resistors 1716, 1724, capacitor 1728, Zener diode 1720 and transistor 1722. Optional resistors (not shown) can be connected in parallel with AC coupling capacitors 1702, 1714 if desired to provide a DC path, in embodiments in which the ballast connected to AC coupling capacitors 1702, 1714 checks for a DC path before enabling normal operation.

Resistors 1730, 1726 form a voltage divider that acts as a reference set point which can also be filtered by, for example, a capacitor (not shown). The resulting reference set point is fed to the non-inverting terminal of a comparator 1734 (or similar function such as an op amp) with the voltage from a sense resistor (represented by a voltage V1 1732 in FIG. 17) being fed to the inverting input of the comparator 1734 via an optional filter/time constant (not shown). When the signal from the sense resistor, represented by voltage V1 1732, is larger than the reference set point signal, the comparator 1734 goes low and turns off transistor 1756 which, in turn, turns on transistor 1762, which acts as the over-voltage protection (OVP) transistor, and thus not shunting the current through optional resistors 1766, 1770 (which in many embodiments can be shorted) of the rectified ballast output. In the event that the current sensed is too small, then the comparator output goes high which turns off transistor 1756 which allows the OVP transistor 1762 to be turned on and therefore the current to be shunted through transistor 1762 and optional resistors 1766, 1770.

The optional one-shot circuit 1736 acts to provide an example method of a periodically turning on the auto-restart/hiccup mode such that in the event OVP is triggered, the one-shot circuit 1736 which is connected to the other input of the NAND gate 1755 can be set to periodically set the output of the NAND 1755 high for a relatively short duration (but long enough to turn on the FLR if the condition resulting in the over-voltage has cleared) allowing transistor 1756 to be turned on and thus turning off transistor 1762. Resistor 1772 represents the rest of the FLR including the LED (or OLED) load. Other embodiments of the present invention reverse the input to the comparator 1734 with the reference connected to the inverting input of the comparator and a voltage divider attached to the output of the diode bridge shown in FIG. 17 (which could be replaced by a synchronous transistor bridge) with the center of the voltage divider connected to the non-inverting input of the comparator 1734 such that when an over-voltage condition exists, the comparator 1734 goes high and turns off transistor 1756 allowing the over-voltage transistor 1762 to be turned on resulting in the current being shunted through transistor 1762 and any components attached/connected to transistor 1762 such as optional resistors 1766, 1770. Again, in general, embodiments of the present invention can use AND, OR, NAND, NOR, and/or other types of Boolean Algebra operations and operations to accomplish various types of functions including but not limited to the optional hiccup mode all or some of which can be incorporated and built into an ASIC or IC, etc.

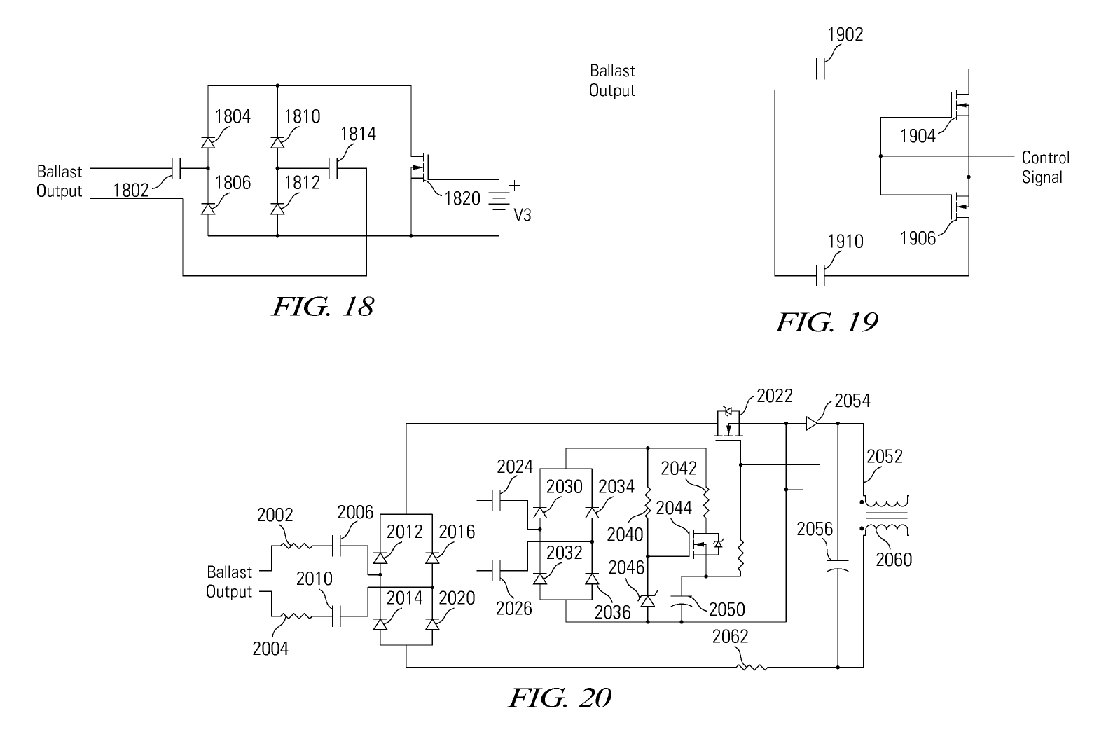

FIG. 18 shows an example of an implementation of the present invention that can be used to reduce, limit or effectively short out the output voltage of the ballast. Capacitor 1802 and optional capacitor 1814, connected across the ballast output, are used to short out the ballast voltage using transistor 1820 which can effectively block the high frequency DC voltage due to the AC to DC rectification of diodes 1804, 1806, 1810, 1812. When a voltage (or current for current-controlled devices such as bipolar transistors) high enough to turn on transistor 1820 is applied between the gate and source of transistor 1820, as represented by voltage V3 in FIG. 18, where V3 can be supplied by a control and/or one or more hazard/fault detection circuits, the output voltage of the ballast can be shorted.

FIG. 19 shows another example of an implementation of the present invention that can be used to reduce, limit or effectively short out the output voltage of the ballast in which a bidirectional switch can be used. In this embodiment, the shorting is performed on the AC side of a rectifier. As shown and illustrated in the example embodiment of FIG. 19, capacitor 1902 and optional capacitor 1910 can via a bidirectional (+/−) composite transistor made up of transistors 1914, 1906 with the gates and sources of tied together can be used to short out the output voltage of the ballast when an appropriate voltage/signal is applied to the gates of transistors transistors 1914, 1906. Note that although only one transistor (MOSFET) is shown in FIG. 18 and two transistors (MOSFETs) are shown in FIG. 19, any combination of transistors in series and/or parallel that achieve an appropriate or needed voltage may be used including, but not limited to, cascoded/stacked transistors including FETs of any appropriate type such as N-type and/or P-type MOSFETs, JFETs, MESFETs, GaN FETs, SiC FETs, BJTs, Darlington BJTs, HBTs, etc.

Now turning to FIG. 20, an example embodiment of the present invention is depicted and illustrated. Resistors 2002, 2004 connected to the ballast output can either be optional fuses, act as an optional fuse (i.e., a fuse resistor) or be shorted out and omitted; capacitors 2006, 2010 and diodes 2012, 2014, 2016, 2020 form an illustrative example embodiment of a current limiter/protection and rectification stage. Transistor 2022 acts as a protection in terms of hazard and leakage current and is designed and intended to prevent leakage current from passing through the present invention through a human or animal, etc. to ground when transistor 2022 is off. In other embodiments and implementations of the present invention, a signal that for example, is either mechanical (including but not limited to motion and rotation based) or electrical or both can be used to turn off the switching element or switching elements in, for example, a buck (or buck-boost, boost-buck, boost, SEPIC, fly back, forward converter, push-pull, etc.) converter and therefore turn off the switching converter action until the present invention is properly inserted into the respective light fixture as a FLR. Transistor 2022 is powered by the ballast output via a floating power supply consisting of capacitors 2024, 2026 and diodes 2030, 2032, 2034, 2036 that is further optionally regulated by resistors 2040, 2042, transistor 2044, Zener diode 2046 and capacitor 2050.

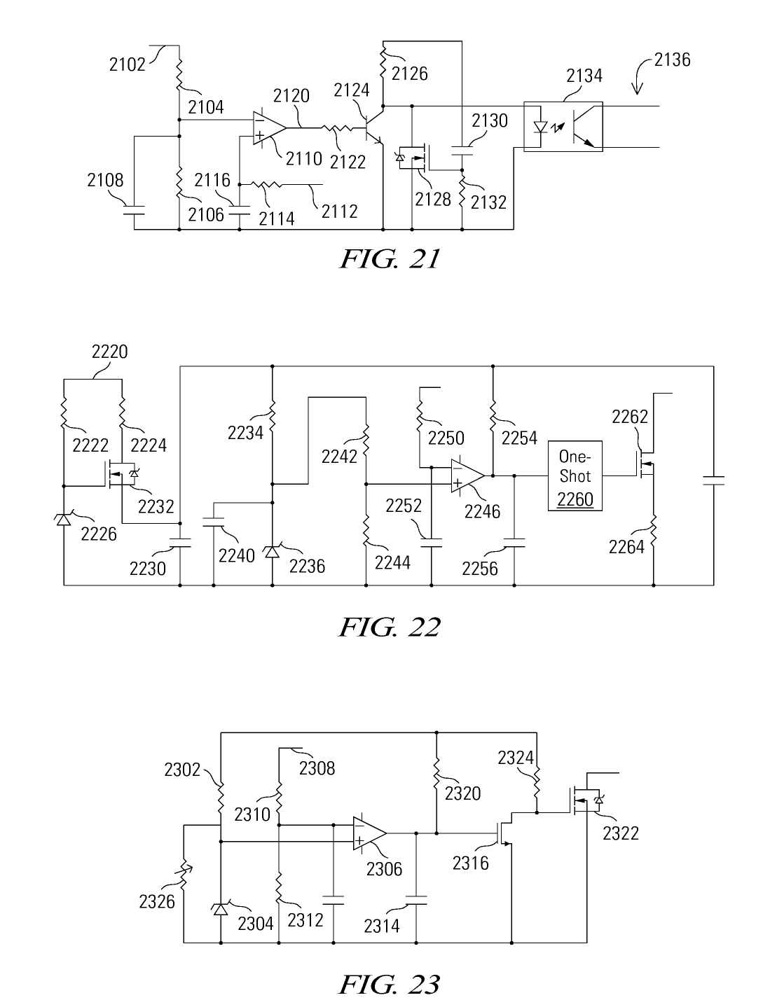

A mechanical switch can be used to short out the gate to source voltage of transistor 2022 when pins on the fluorescent lamp replacement are exposed, turning off transistor 2022 and preventing current from flowing through the pins to load output 2052 through diode 2054. In such an embodiment, when the fluorescent lamp replacement was fully installed and the pins are no longer exposed, the mechanical switch would open, allowing transistor 2022 to conduct. In other embodiment, an optocoupler (e.g., 2134, FIG. 21) is connected across the gate and source of transistor 2022 to short out the gate to source voltage when, for example, a fault condition is detected.

Diode 2054 allows the voltage at the anode of diode 2054, which is the rectified input voltage, to be pulled down and the ballast current shunted through a shunt transistor such as transistor 2262, FIG. 22 or transistor 2322, FIG. 23 without also pulling the voltage down across capacitor 2056 and the output of the optional choke and/or inductor 2060 and/or transformer which is connected to the LED or OLED load. Resistor 2062 in FIG. 20 is used as a current sense resistor and is fed to other parts of the present invention.

Turning now to FIG. 21, an example embodiment of one type of detection circuit for shock hazard control is depicted. Op amp (or comparator) 2110 drives transistor 2124 via resistor 2122 if the non-inverting input which is, for the example shown, a voltage divider consisting of resistors 2104, 2106 and optional capacitor 2108 which provides a voltage reference to compare against the inverting input signal coming from feedback signal 2112 representing the voltage across resistor 2062 which, for example, senses and measures the current of FIG. 20 via optional filter consisting of resistor 2114 and capacitor 2116. In the event that the signal from resistor 2062 in FIG. 20 is low, then Op amp (or comparator) 2110, FIG. 21 puts out a low signal that turns off transistor 2124 which allows the input current to optocoupler 2134 to flow via resistor 2126 thus allowing optocoupler 2134 to short out the gate to source of transistor 2022 in FIG. 20. Capacitor 2130 and resistor 2132 form an RC time constant that is used to temporarily turn on transistor 2128 resulting in optocoupler 2134 being shorted out for a relatively short period of time during the initial turn-on phase—i.e., the turn-on/supplying of power/current to the FLR.

In addition to or in place of the sense circuit a switch can be used to, for example, short out the voltage across the Zener diode 2046 in FIG. 20 so as to turn off transistor 2022; such a switch could be normally closed (NC) and, in many cases, be a low voltage switch that, for example, is momentarily closed, a two position single pole slide or rotary switch, a switch that is normally closed and then opened by rotation or depression of springs, etc. In general most types of switches are suitable for use with the present invention as the voltage is low—typically less than 30 volts and often around 15 to 16 V and the current is also typically very low. In some embodiments of the present invention the switch may be also used to turn off the buck (or buck-boost, boost-buck, boost, fly back, forward converter, push-pull, etc.) switching device or devices (i.e., transistors) by, for example, and not limited in any way or form, shorting the gate to source of, for example a MOSFET or MOSFETs. The switch may be used with single direction (i.e., DC) switching elements or bidirectional (i.e., AC) switching elements in any appropriate manner. In addition, other configurations may use normally open switches for the shock hazard/pin safety protection in which, for example, the switch is set from protect mode to operation mode such that transistor 2022 and/or the switching elements are able to be switched on and off at typically relatively high frequencies again in the range of typically 20 kHz to over 100 kHz. In some embodiments of the present invention a microcontroller or microcontrollers (and/or FPGAs, microprocessors, DSPs, CLDs, etc.) can, for example, use an input to detect the state of a switch (e.g., normally open (NO) or normally closed (NC)) and, for example, set transistor 2022 and/or other switching devices/transistors to the on/operational state or the off/gate-to-source shorted state depending on the state of the operate/protect state of the switch and, for example, the associated signal(s).

Turning to FIG. 22, an example embodiment of a ballast control circuit is illustrated and depicted. The control circuit has an optional power supply source that takes power from a rectified power supply at node 2220 that is optionally further regulated using the regulator consisting of resistors 2222, 2224, Zener diode 2226, capacitor 2230 and transistor 2232. Resistor 2234 and Zener diode 2236 along with optional capacitor 2240 form an example voltage reference (although other types of voltage references can be used to achieve a stable voltage reference including, but not limited to, bandgap references, precision voltage references, etc.). Resistors 2242, 2244 form a voltage divider that acts as a reference set point which could also be filtered by, for example, a capacitor (not shown) that is fed to the non-inverting terminal of a comparator 2246 (or similar function such as an op amp). The voltage from a sense resistor (e.g., resistor 2062 in FIG. 20) is fed to the inverting input of the comparator 2246 via an optional filter/time constant consisting of resistor 2250 and capacitor 2252 such that when the signal from the sense resistor (e.g., resistor 2062 in FIG. 20) is larger than the reference set point signal, the comparator 2246 goes low and provides a negative pulse.

The negative pulse from comparator 2246 triggers, for example, a one-shot circuit 2260, or timer circuit, monostable multivibrator, pulse generator, etc., which in turn, generates a pulse that turns on transistor 2262 for a predetermined time duration. In some embodiments, one-shot circuit 2260 is replaced with an inverter such as, but not limited to, a series bipolar junction transistor and resistor, with the base of the BJT controlled by the output of the comparator 2246, and with the inverter output between the BJT and resistor driving the gate of transistor 2262. In some embodiments, one-shot circuit 2260 is replaced with an inverter such as, but not limited to, a series field effect transistor transistor and resistor, with the gate of the FET controlled by the output of the comparator 2246, and with the inverter output between the FET and resistor driving the gate of transistor 2262. A time constant can be included to control the rise and/or fall time at the gate of the FET.

The drain of transistor 2262 is attached between the source of transistor 2022 and diode 2054 in FIG. 20 and acts as a shunting transistor, shunting the current of the rectified ballast output through resistor 2264 which in some embodiments may be replaced by a short. Again, this shorts out the ballast and prevents current from reaching the load or capacitor 2056, while diode 2054 prevents capacitor 2056 from being discharged and also turning off the load. Optional resistors may be used between the drain of transistor 2262 and the source of transistor 2022 and diode 2054 of FIG. 20. In the event that the current sensed is too high, then the output of the comparator 2246 (or op amp) goes low which results in turning on transistor 2262 and allows the current to be shunted through transistor 2262 and any optional resistors for a prescribed amount of time. Other embodiments of the present invention may use different implementations, circuits, etc. that perform the same/similar function/operation, etc. Again, in general, embodiments of the present invention can use any type or form of circuit, implementation, design, etc.

Turning now to FIG. 23, another example embodiment of an over-voltage protection (OVP) and over-temperature protection (OTP) is shown and illustrated. In this particular embodiment, the over-voltage protection has a voltage reference such as, but not limited to, resistor 2302 and Zener diode 2304 that acts as a reference set point which could also be filtered by, for example, a capacitor (not shown) that is fed to the non-inverting terminal of a comparator 2306 (or similar function such as an op amp). The reference set point is compared in comparator 2306 with, for example, a voltage, scaled in voltage divider 2310, 2312, at node 2308, which is the voltage used to drive the LED or OLED or QD load (e.g., node 2052, FIG. 20). The scaled voltage is fed to the inverting input of the comparator/op amp 2306. An optional filter/time constant (not shown) may be used but is not required such that filtering output voltage takes place. When the scaled voltage is larger than the reference set point signal, the comparator 2306 goes low with a negative pulse, discharging capacitor 2314 and turning off transistor 2316, allowing the gate of transistor 2322 to be pulled up through resistor 2324 and turning on OVP transistor 2322. When the comparator 2306 goes high, capacitor 2314 is charged through resistor 2320, turning on transistor 2316 and shorting the gate of transistor 2322, turning off OVP transistor 2322.

OVP transistor 2322 shunts the current of the rectified ballast output that drives/supplies the LED or OLED or QD load, shutting off the current through the exposed pin(s) of the fluorescent lamp replacement. The drain of transistor 2322 may be connected between the source of transistor 2022 and diode 2054 of FIG. 20. Other embodiments of the present invention can perform current shunting such that when an over-voltage condition exists, the output voltage is limited to an appropriate value allowing the over-voltage transistor to be turned on resulting in the current being shunted through the OVP and/or away from the output of the FLR driver or to block the current from flowing using, for example, but not limited to, transistor 2022 of FIG. 20. In addition, other protection circuits, functions and features can be added/incorporated into the present invention. For example, FIG. 23 also contains an over-temperature protection function—such a function is performed by, for example, but not limited to, a thermistor 2326 in parallel with Zener diode 2304 with both in series with resistor 2302. For example, thermistor 2326 can be but is not limited to a negative temperature coefficient (NTC) thermistor such that the resistance of thermistor 2326 decreases as the temperature increases thus eventually dropping the voltage across thermistor 2326 in parallel with Zener diode 2304, below the Zener voltage of diode 2304 which can be used to turn on the OTP circuit via the series resistance voltage divider of resistor 2302 and thermistor 2326 at a lower voltage and even turn-off the output current of the FLR to the LED and/or OLED and/or QD load. Again, in general, embodiments of the present invention can use AND, OR, NAND, NOR, and/or other types of Boolean Algebra operations and operations to accomplish various types of functions including but not limited to the optional hiccup mode.

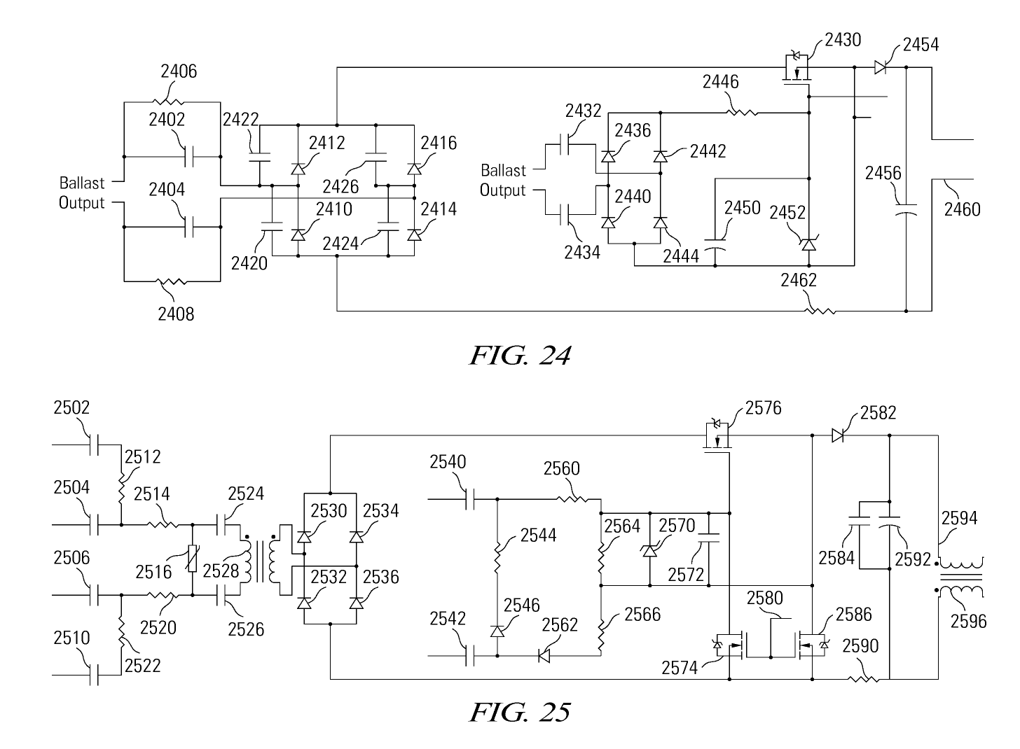

FIG. 24 shows and depicts another example embodiment similar to that of FIG. 20. In this embodiment, resistors 2406, 2408 are shown in parallel with current limiting capacitors 2402, 2404, providing a DC current path to cause particular ballasts to operate correctly. Optional capacitors 2410, 2412, 2414, 2416 are connected in parallel across corresponding high-frequency rectification diodes diodes 2420, 2422, 2424, 2426 (which could be replaced or augmented by synchronous transistors to form the rectification process). One or more (or less) capacitors can be added to each of the diodes 2420-2426 (or synchronous transistors) to achieve benefits in performance including reduced electromagnetic interference/electromagnetic compatibility (EMI/EMC) including, but not limited to, radiated EMI. Although only capacitors 2410-2416 are shown, other components including resistors, snubbers, clamps, etc. of any type or form may also be used.

Transistor 2430 acts as a protection in terms of hazard and leakage current and is designed and intended to prevent leakage current from passing through the present invention through a human or animal, etc. to ground when transistor 2022 is off. Transistor 2430 is powered by the ballast output via a floating power supply consisting of capacitors 2432, 2434 and diodes 2436, 2440, 2442, 2444 that is further optionally regulated by resistor 2446, capacitor 2450 and Zener diode 2452.

A mechanical switch can be used to short out the gate to source voltage of transistor 2430 when pins on the fluorescent lamp replacement are exposed, turning off transistor 2430 and preventing current from flowing through the pins to load output 2460 through diode 2454. In such an embodiment, when the fluorescent lamp replacement was fully installed and the pins are no longer exposed, the mechanical switch would open, allowing transistor 2430 to conduct. In other embodiment, an optocoupler (e.g., 2134, FIG. 21) is connected across the gate and source of transistor 2430 to short out the gate to source voltage when, for example, a fault condition is detected.

Diode 2454 allows the voltage at the anode of diode 2454, which is the rectified input voltage, to be pulled down and the ballast current shunted through a shunt transistor such as transistor 2262, FIG. 22 or transistor 2322, FIG. 23 without also pulling the voltage down across capacitor 2456 and the load output 2460 or any optional choke and/or inductor (not shown) which may be connected to node 2460 to power the LED or OLED or QD load. Resistor 2462 is used as a current sense resistor and is fed to other parts of the present invention.

FIG. 25 shows and depicts a version of the present invention suitable for use with both instant start and rapid start ballasts, that implements and allows for current transformation and also allows for emulation of the heater/cathodes in conventional hot cathode florescent tube lamps (HCFL) including, for example, but not limited to less than 1 ft to greater than 8 ft long T5, T8, T9, T10, T12, etc. HCFLs, FLs, CFLs, CCFLs, etc. for use in and with all types of ballasts including, but not limited to, instant-on, instant start, rapid start, programmed start, programmable start, pre-heat, etc. ballasts and any type and form including magnetic and/or electronic ballast(s).

In FIG. 25, a hazard protection circuit includes a transistor 2576 that turn off current through load output 2594, and thus through the exposed pins of the fluorescent lamp replacement. Capacitors 2502, 2504 and resistor 2512, and capacitors 2506, 2510 and resistor 2522 form a pair of heater emulation circuits, respectively, with capacitors 2504 and/or 2510 (or 2502 and/or 2506) being optional capacitors. In some embodiments 2512, 2522 can be set to very small values or completely shorted out. In other embodiments resistors can be each individually placed in parallel with capacitors 2502, 2504, respectively as well as capacitors 2506, 2510. Resistors 2514, 2520 could be fuses or fuse resistors or thermistors to protect or current limit in conjunction with capacitors 2524, 2526. Capacitors 2524, 2526 can also provide additional protection including protection from AC line and/or, for example in certain specific applications, magnetic ballasts in certain embodiments of the present invention. In certain embodiments of the present invention, resistors can also be placed in parallel with capacitors 2524 and 2526, respectively. An optional varistor 2516 of any type or form including metal oxide varistors (MOVs), etc. can also be used to limit the voltage that the FLR experiences and/or may be subjected to—however in many embodiments and implementations of the present invention these are not used. Optional transformer 2528 provides current to current and/or voltage to voltage transformation allowing the LED or OLED or QD load connected to load output 2594 to be an appropriate value with for, example, a higher or lower current than typically supplied by the ballast. In some cases and embodiments transformer 2528 is not used. Diodes 2530, 2532, 2534, 2536 form a full wave rectification bridge (which could also consist of synchronous transistors). Capacitors 2540, 2542, diodes 2546, 2562 and resistors 2544, 2560, 2564, 2566 and Zener diode 2570 along with optional capacitor 2572 form a floating power supply connected to the ballast output that can be used to provide the gate turn-on voltage to transistor 2576, a hazard/leakage/fault protection transistor/switch, as well as providing current, voltage and power to other parts of the FLR. Other circuits and implementations can be used for this power supply including some additional examples discussed herein. Diode 2582 is used to isolate the optional output load capacitors 2584, 2592, optional choke 2596 connected to load output 2594, and any LED or OLED or QD load connected to optional choke 2596 or load output 2594 from events including control and protection/limit events that shunt and bring down/reduce the voltage at the anode of diode 2582 in FIG. 25. Resistor 2590 represents the current sense which could be a resistor, current transformer, inductor, sense element of any type or form, etc. Transistor 2574 is turned on to shunt and short the gate of 2576 during fault conditions. Optional transistor 2586 can be used to connect the floating supply ground to the ground of the FLR. Transistors 2574, 2586 can share the same control and protection signals as shown in FIG. 25 or may have separate signals or a subset of shared signals, etc.

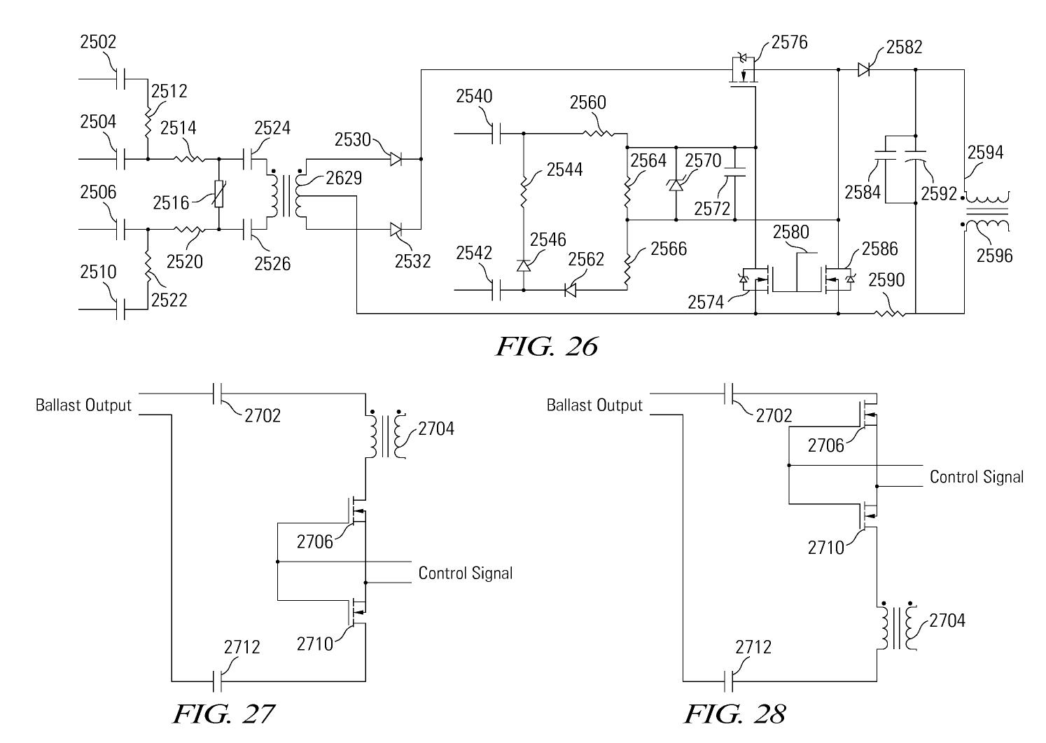

Turning now to FIG. 26 which illustrates and depicts another implementation of the present invention in which a transformer 2629 with a center tapped secondary is used such that only two diodes 2530, 2532 or synchronous transistors are needed to realize and attain full wave rectification. Note that the primary of the transformer 2528 in various implementations may also be center tapped. Again resistors can be added or remove, put in parallel or series including being put in parallel with capacitors 2524 and 2526. In addition other windings may be used with the present invention to provide power including, but not limited to, bias and auxiliary power, current, voltage, etc. including isolated power, current, voltage, etc. as needed. These other power supplies may be isolated and may be of any type including, but not limited to, forward, flyback, resonant, current-mode, voltage-mode, current-fed, voltage-fed, etc.

Hazard/leakage/shock protection can be implemented as discussed, illustrated, shown, depicted, discussed, etc. herein including before (for example, using a bidirectional switch to stop/block/etc. the current/voltage from the ballast), after the rectification stage, transformer, etc.

The example heater/cathode emulation circuits shown in FIGS. 25 and 26 in which capacitors 2502, 2504 and resistor 2512, and capacitors 2506, 2510 and resistor 2522 form an example pair of heater emulation circuits, respectively, with capacitors 2504 and/or 2510 (or 2502 and/or 2506) being optional capacitors can also be used with the present invention including but not limited to the figures, illustrations and discussions presented herein. In addition, circuit functions and features illustrated, depicted, discussed, etc. herein that use analog and/or digital circuits may be implemented using microcontrollers, microprocessors, digital signal processors (DSPs), field programmable gate arrays (FPGAs), etc.

Hazard/leakage/shock protection can also be accomplished by inserting a bidirectional switch (i.e., in either or both legs of the primary of the transformer. For example, an example embodiment of the present invention would include inserting the primary of the transformer 2704 in between capacitor 2702 and transistor 2706 or in between capacitor 2712 and transistor 2710 as illustrated and depicted in FIGS. 27 and 28. The gates of the bidirectional switches can be powered from a floating power supply such as illustrated and depicted in, for example, FIGS. 14, 25 and 26 with, for example, a similar detect/monitor and control approach as described herein and depicted, for example, in FIGS. 14, 15, 16, 25 and 26.

The use of capacitors, a switch with capacitors, capacitors and diode bridge or other method of rectification including synchronous transistors, bidirectional switch(es) without the need for a rectifier, including versions that use digital and/or analog and/or microcontrollers, microprocessors, DSPs, FPGAs, etc. can be used to short out the ballast. Capacitors 1402 and/or 1404 (FIG. 14) can also be used to limit the maximum current from the ballast and provide protection including, but not limited to protection from damage to the ballast due to voltage and/or current levels from or across the 50 or 60 Hz AC lines. In some embodiments of the present invention only one capacitor (i.e., 1402 or 1404) is included which could consist of a single capacitor or multiple capacitors that could for example be put in series, in parallel, in combinations of series and parallel, etc. In other embodiments of the present invention two or more capacitors are used. In some embodiments of the present invention, use of capacitors such as 1402 and/or 1404 in FIG. 14 or corresponding capacitors in other Figs. or any subset or combinations of these may result or assist/aid in increased efficiency. The impedance of these capacitors, for example, can be used to increase the effective AC resistance at the ballast frequency to reduce the voltage (and current) burden while also limiting or assisting in limiting the short circuit current through the ballast in the case of a shorting or shunting event or abnormality.

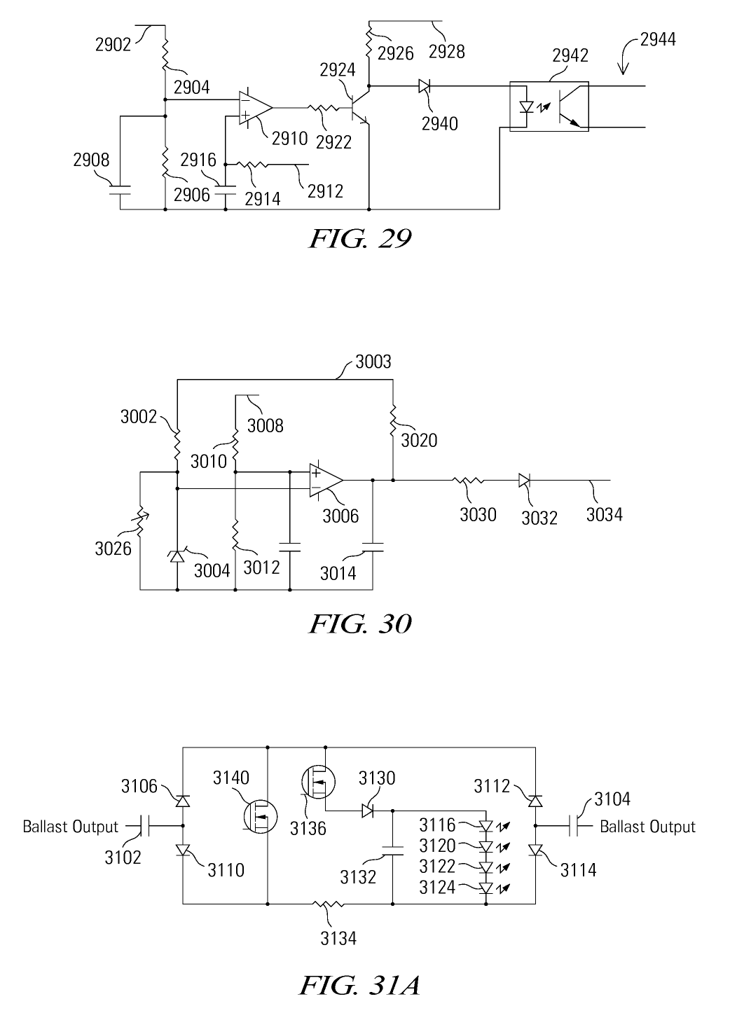

FIG. 29 depicts another example embodiment of a detection circuit for shock hazard control is depicted. Op amp (or comparator) 2910 drives transistor 2924 via resistor 2922 if the non-inverting input which is, for the example shown, a voltage divider consisting of resistors 2904, 2906 and optional capacitor 2908 which provides a voltage reference to compare against the inverting input signal coming from feedback signal 2912 representing the voltage across resistor 2062 of FIG. 20 via optional filter consisting of resistor 2914 and capacitor 2916. In the event that the signal from resistor 2062 in FIG. 20 is low, then Op amp (or comparator) 2910 puts out a high signal that drives and turns on transistor 2924 which shorts out the input current to optocoupler 2942 via optional diode 2940 thus preventing optocoupler 2942 from shorting out the gate to source of transistor 2022 in FIG. 20 using output 2944 of optocoupler 2942. The use of diodes, for example, permits multiple outputs to potentially be connected to the optocoupler allowing shutdown of the optocoupler due potentially to multiple reasons and also allowing on/off sequencing which can be helpful with certain types of ballasts. When the voltage at feedback signal 2912 representing the voltage across resistor 2062 of FIG. 20 is too low, the comparator 2910 turns off transistor 2924, the current through resistor 2926 from Vdd_15 2928 flows through optocoupler 2942, shorting out the gate to source of transistor 2022 in FIG. 20 and turning off the current through the load and therefore through the pins of the fluorescent lamp replacement. In other embodiments, the inverter of transistor 2924 and resistor 2926 is replaced with a one-shot circuit, or timer circuit, monostable multivibrator, pulse generator, etc.

Turning now to FIG. 30, another example embodiment of an over-voltage protection (OVP) and over-temperature protection (OTP) is shown and illustrated. In this particular embodiment, the over-voltage protection has a voltage reference such as, but not limited to, resistor 3002 and Zener diode 3004 that acts as a reference set point based on voltage rail Vdd_15 3003 which could also be filtered by, for example, a capacitor (not shown) that is fed to the inverting terminal of a comparator 3006 (or similar function such as an op amp). The reference set point is compared in comparator 3006 with, for example, a voltage, scaled in voltage divider 3010, 3012, at node 3008, which is the voltage used to drive the LED or OLED or QD load (e.g., node 2052, FIG. 20). The scaled voltage is fed to the non-inverting input of the comparator/op amp 3006. An optional filter/time constant (not shown) may be used but is not required such that filtering output voltage takes place. When the scaled voltage is lower than the reference set point signal, the comparator 3006 goes low with a negative pulse, discharging capacitor 3014 and turning off the current through resistor 3030, diode 3032 to shutdown signal 3034. When the scaled voltage is higher than the reference set point signal, the comparator 3006 goes high, turning on the current through resistors 3020, 3030, diode 3032 to shutdown signal 3034. Shutdown signal 3034 can be used to drive an optocoupler to short the drain to source of transistor 2022 of FIG. 20, or of transistor 2430 of FIG. 24, or of transistor 2576 of FIG. 25, or of transistor 2676 of FIG. 26.

In addition, other protection circuits, functions and features can be added/incorporated into the present invention. For example, FIG. 30 also contains an over-temperature protection function—such a function is performed by, for example, but not limited to, a thermistor 3026 in parallel with Zener diode 3004 with both in series with resistor 3002. Again, in general, embodiments of the present invention can use AND, OR, NAND, NOR, and/or other types of Boolean Algebra operations and operations to accomplish various types of functions including but not limited to the optional hiccup mode.

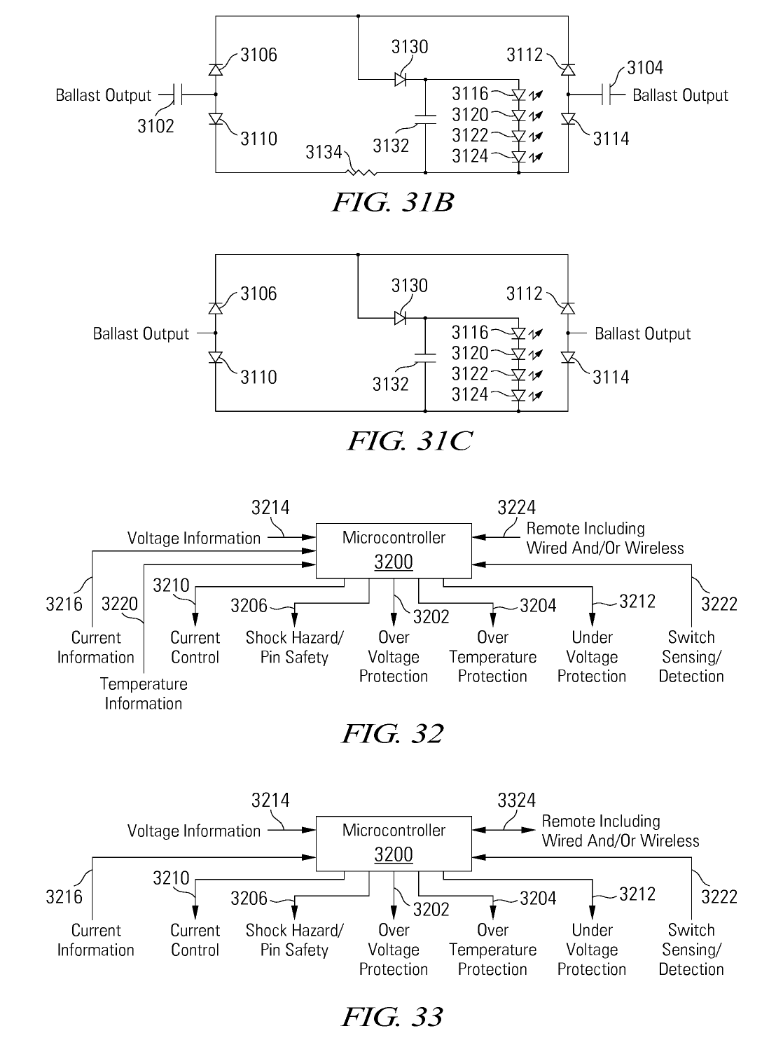

FIGS. 31A-C depict versions of the present invention illustrating physically split apart high frequency rectification components that also can provide current limit and protections. In other words, the embodiments of FIGS. 31A-C comprise divided rectifier bridges, each having two halves that can be physically located in the end caps of the fluorescent lamp replacement. Turning to FIG. 31A, capacitors 3102, 3104 are connected to the ballast output at opposite ends of the fluorescent lamp replacement. Capacitor 3102 is followed by diodes 3106, 3110 as a first half of the rectified bridge. At the other end of the fluorescent lamp replacement, capacitor 3104 is followed by diodes 3112, 3114 as the second half of the rectified bridge. LED's (e.g., 3116, 3120, 3122, 3124) are powered by the rectified current from the divided rectifier bridge. Other components can be included as desired, such as, but not limited to, current control circuits, current to current converters, (not shown), fault detection circuits, etc., diode 3130, capacitor 3132 in parallel with the load, current sense resistor 3134, other protection, etc. A load current switch 3136 can be included in series with the load, hazard protection switch 3140 can be included at any suitable location to shunt current to prevent current from flowing to an abnormal ground in contact with an external pin, etc.

Turning now to FIG. 32, some embodiments of the present invention may use and/or incorporate microcontrollers (e.g., 3200), FPGAs, microprocessors, DSPs, CLDs, etc. to perform some or all of the functions and capabilities of the present invention including but not limited to detecting and asserting control signals identifying: over voltage 3202, over temperature 3204, shock hazard/pin safety 3206, current control 3210 (i.e., constant current, overcurrent, current to current conversion, etc.), under voltage protection 3212, transient protection, etc. by using signals either directly or derived, filtered, modified, scaled, etc. from voltage(s) 3214, current(s) 3216, temperature(s) 3220, etc. associated, for example, with the ballast and the present invention. A switch 3222 or switches may be directly or indirectly (i.e., isolated, through other circuits, scaled, etc.) connected to the microcontroller, etc. or may be directly connected to the microcontroller, etc. with or without additional components and used to detect the state of the switch (i.e., open or closed including fixed, CW, momentary, 1, 2 or more pole, 1, 2 or more throw, etc.) in terms of enabling or disabling or taking other action(s) when it comes to shock hazard. The microcontroller 3200, etc. can work in conjunction with other components, circuits, switches, devices, etc. including but not limited to those discussed herein. In addition, although not shown in FIGS. 32 and 33, the frequency of the ballast or AC line can be detected, measured, sampled, sensed, analyzed, recorded, stored, etc. for a number of purposes and uses including but not limited to determining whether an electronic ballast is connected to the present invention and making and taking appropriate decisions and actions based on the frequency information/signal. Note: the switch or switches used for shock hazard/pin safety protection of embodiments of the present invention protection can include any suitable semiconductor transistor, including but not limited to bipolar, MOSFET, IGBT, JFET, etc., relay(s) including but not limited to coil, contact, mechanical, electromechanical, Reed, mercury, mercury-wetted, vacuum, solid state, semiconductor, etc. in single, parallel, series, stacked, etc., combinations of these, etc. A remote control signal 3224 can be used to signal to the microcontroller 3200 that the fluorescent lamp replacement has been correctly installed and that pins are enclosed in the fixture. The microcontroller 3200 can then disable the shock hazard/pin safety 3206 system to enable current to flow through the pins to power the load. Turning to FIG. 33, in some embodiments, the remote control signal 3324 is bi-directional, allowing the microcontroller 3200 to transmit status information to a remote device such as a computer, tablet, phone, etc. about the fluorescent lamp replacement. Again, in addition, although not shown in FIGS. 32 and 33, the frequency of the ballast or AC line can be detected, measured, sampled, sensed, analyzed, recorded, stored, etc. for a number of purposes and uses including but not limited to determining whether an electronic ballast is connected to the present invention and making and taking appropriate decisions and actions based on the frequency information/signal.

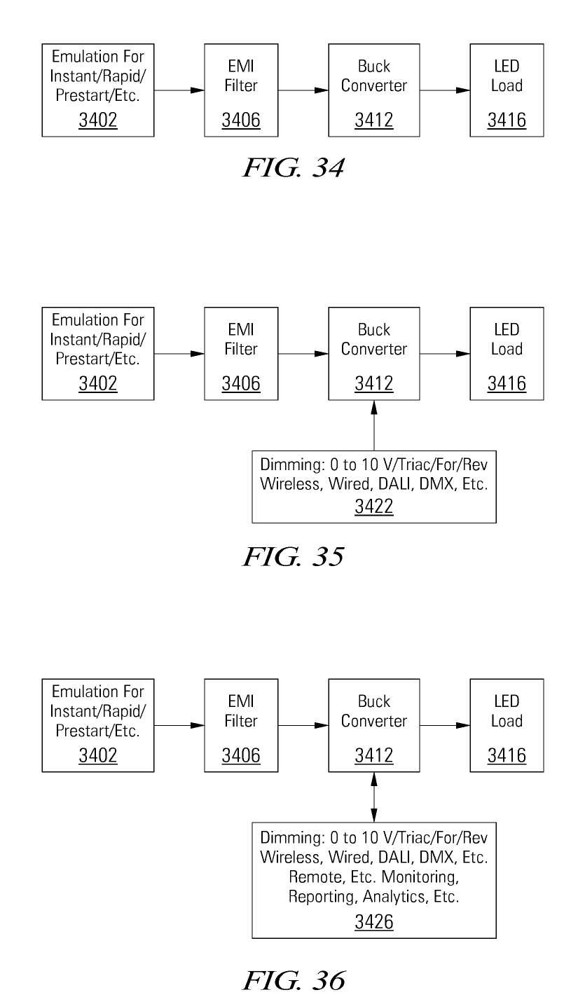

Turning now to FIG. 34, a block diagram of a fluorescent lamp replacement circuit is depicted that can be used with shock hazard/pin safety protection. An emulation circuit 3402 can be included to emulate various characteristics of an instant start, rapid start, prestart phases of operation in a replaced fluorescent lamp in order that the corresponding ballast operate correctly with the fluorescent lamp replacement. An EMI filter 3406 can be included to manage electromagnetic interference. A power supply such as, but not limited to, a buck converter 3412 or, for example, a buck-boost, boost-buck, boost, fly back, forward converter of any type and kind, push-pull, etc. can be included to power an LED load 3416 from the ballast output.

The buck converter 3412 can also be a boost-buck, buck-boost, boost, etc. converter. The LED load 3416 may comprise LEDs, OLEDs, QDs, combinations of these, etc. A circuit as disclosed elsewhere herein that contains at least one diode, at least one inductor, and/or at least one switching element/switch can also be included to provide AC line and ballast current control operation and also to manage shock hazard/pin safety. The buck converter 3412 can have OVP, OTP, OCP, shock hazard/pin safety protection, constant current, etc. Normally on (NO) and normally closed (NC) mechanical switches that are, for example single or double (or higher) and single (or higher) pole can be used to indicate when external pins on the fluorescent lamp replacement are exposed.

The present invention including the figures depicted above can be used with AC line voltage including but not limited to 80 to 305 VAC 50/60 Hz, 347 VAC 50/60 Hz, other 50/60 Hz voltages, magnetic and electronic ballasts, low frequency and high frequency ballasts, instant start, rapid start, programmed start, program start, pre-start, warm, cold, hot types of ballasts, etc.

Many embodiments and implementations of the present invention use the ballast itself to set the frequencies and time periods rather than using internally generated frequencies or periods. Some embodiments and implementations of the present invention use both the ballast generated signals and frequencies (and periods) and internally generated frequencies and periods as well as combinations of these, etc. Other embodiments and implementations may use internal signals, frequencies, periods, etc.

As shown in FIG. 35, the buck converter 3412 or other power supply can be controlled by a dimming signal 3422 as described herein. A dimming controller 3426 can also receive status information as shown in FIG. 36 and as described herein.

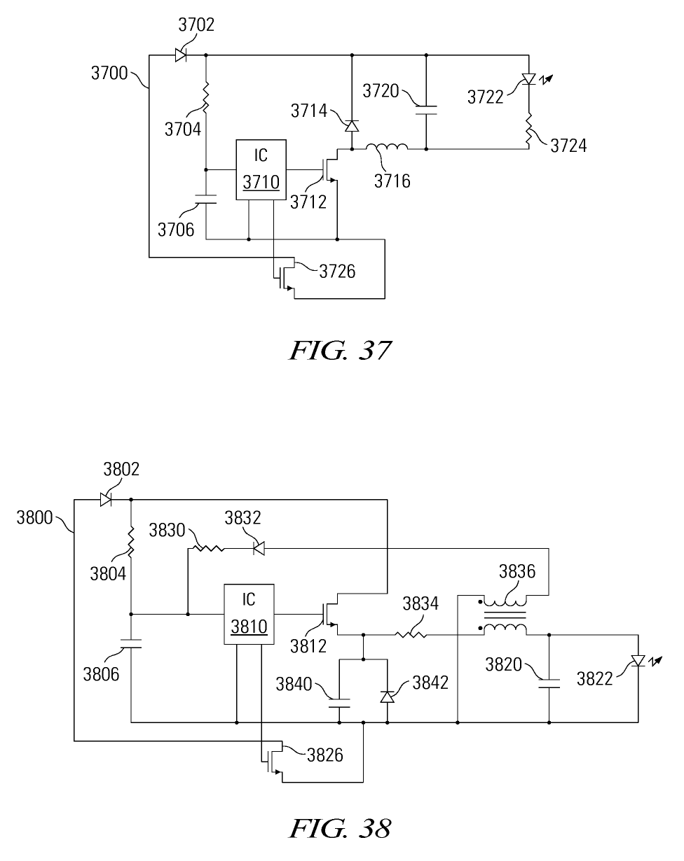

Turning now to FIG. 37, an example embodiment of a fluorescent lamp LED replacement is depicted with hazard/leakage protection and with inductor-driven load output. Constant current can be supplied to the load 3722 from an input current 3700 through diode 3702, resistor 3724, inductor 3716, and transistor 3712. When a control circuit 3710 turns on switch 3712, current is allowed to flow through the load 3722 and to charge the inductor 3716. When current begins to rise as measured using sense resistor 3724, the control circuit 3710 turns off switch 3712, and stored energy from the inductor 3716 flows through diode 3714 and through the load 3722. The control circuit 3710 can thus regulate and control the current through the load 3722 by turning on and off the transistor 3712. The control circuit 3710 can use reference voltages and/or currents from any suitable sources, and time constants can be applied as desired, for example with resistor 3704 and capacitor 3706. Note that the positions of the switching transistor or transistors (e.g., 3712 and 3812) shown in FIGS. 37 and 38 along with the respective storage/switching inductors 3716 and 3836 (or transformers, etc.) and buck (or buck-boost, boost-buck, boost) diode 3714, 3842) in FIGS. 37 and 38 may be, in general, located in different positions in the respective schematic drawings and perform the same buck, buck-boost, boost-buck, or boost functions and operations, all of which, for example, can also be used to perform current to current conversion. An example of current to current conversion is, for example, when the ballast output current is different than the load current.

When an over-voltage, over-current, over-temperature or other condition is detected, the control circuit 3710 can short out the current from the ballast output at node 3700 using transistor 3726, preventing current from node 3700 from reaching the load 3722. Diode 3702 prevents capacitor 3720 from being discharged by the short.

Turning now to FIG. 38, an example embodiment of a fluorescent lamp LED replacement is depicted with hazard/leakage protection and with transformer-driven load output. Constant current can be supplied to the load 3822 from an input current 3800 through diode 3802, transistor 3812, resistor 3834, and transformer or inductor with a tagalong winding 3836. When a control circuit 3810 turns on switch 3812, current is allowed to flow through the transformer or inductor with a tagalong winding 3836 and load 3822, charging the inductive winding of transformer or inductor with a tagalong winding 3836. When current begins to rise as measured using sense resistor 3834 or in other manners, or in response to other conditions, the control circuit 3810 turns off switch 3812, and stored energy from the transformer or inductor with a tagalong winding 3836 flows through diode 3842 and through the load 3822. The control circuit 3810 can thus regulate and control the current through the load 3822 by turning on and off the transistor 3812. The control circuit 3810 can use reference voltages and/or currents from any suitable sources, and time constants can be applied as desired, for example with resistor 3804 and capacitor 3806, and feedback from transformer or inductor with a tagalong winding 3836 through diode 3832 and resistor 3830.

When an over-voltage, over-current, over-temperature or other condition is detected, the control circuit 3810 can short out the current from the ballast output at node 3800 using transistor 3826, preventing current from node 3800 from reaching the load 3822. Diode 3802 prevents capacitors 3820, 3840 from being discharged by the short. A wireless or wired signal can be sent and via reference set point which for example but is not limited to, could be a voltage, the output current to the LED, OLED and/or QD could be reduced or increased as desired. In general, the load current can be higher than the current supplied by the ballast using buck, buck-boost, boost, boost-buck, fly back, forward converters. Cuk, push pull, SEPIC, etc. Also, in general, a voltage can be used to set the dimming level by, for example, decreasing or increasing the voltage with, for example, but not limited to, the voltage being used as a reference and/or set point.

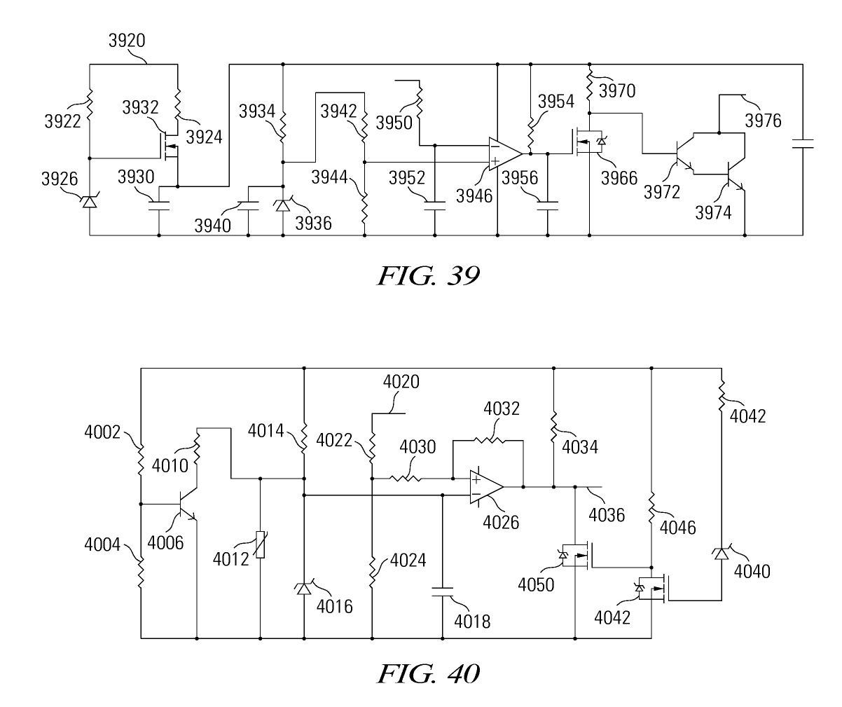

Turning to FIG. 39, an example embodiment of a ballast control circuit is illustrated and depicted. The control circuit has an optional power supply source that takes power from a rectified power supply at node 3920 that is optionally further regulated using the regulator consisting of resistors 3922, 3924, Zener diode 3926, capacitor 3930 and transistor 3932. Resistor 3934 and Zener diode 3936 along with optional capacitor 3940 form an example voltage reference (although other types of voltage references can be used to achieve a stable voltage reference including, but not limited to, bandgap references, precision voltage references, etc.). Resistors 3942, 3944 form a voltage divider that acts as a reference set point which could also be filtered by, for example, a capacitor (not shown) that is fed to the non-inverting terminal of a comparator 3946 (or similar function such as an op amp). The voltage from a sense resistor (e.g., resistor 2062 in FIG. 20) is fed to the inverting input of the comparator 3946 via an optional filter/time constant consisting of resistor 3950 and capacitor 3952 such that when the signal from the sense resistor (e.g., resistor 2062 in FIG. 20) is larger than the reference set point signal, the comparator 3946 goes low and provides a negative pulse.

The negative pulse from comparator 3946 is fed to an inverter made up of MOSFET 3966 and resistor 3970. A time constant can be included to control the rise and/or fall time at the gate of the MOSFET 3966, for example with resistor 3954 and capacitor 3956 and can act, behave and perform as a one-shot. The inverter output is fed to the base of a Darlington pair made up of bipolar junction transistors 3972, 3974 which acts as a shunting transistor. The collector of the Darlington pair at node 3976 can be connected, for example, between the transistor 2022 and the diode 2054 of FIG. 20, or between the transistor 2430 and diode 2454 of FIG. 24, or between the transistor 2576 and diode 2582 of FIG. 25, or between the transistor 2676 and diode 2682 of FIG. 26, shunting the current of the rectified ballast output through the Darlington pair. In other embodiments of the present invention, other types of transistors, including but not limited to, MOSFETs, IGBTs, GaNFETs, SiCFETs, BJTs, etc. can be used in place of the Darlington transistor. Again, this shorts out the ballast and prevents current from reaching the load or capacitor 2056, while diode 2054 prevents capacitor 2056 from being discharged and turning off the load. In the event that the current sensed is too high, then the output of the comparator 3946 (or op amp) goes low which results in turning on the Darlington pair 3972, 3974 (or other types of transistor(s)) to shunt the ballast output current. Other embodiments of the present invention may use different implementations, circuits, etc. that perform the same/similar function/operation, etc. Again, in general, embodiments of the present invention can use any type or form of circuit, implementation, design, etc.

Turning now to FIG. 40, another example embodiment of an over-voltage protection (OVP) and over-temperature protection (OTP) circuit is shown and illustrated. Over-temperature protection is provided by voltage divider resistors 4002, 4004, bipolar junction transistor 4006, resistor 4010 and in some embodiments thermistor 4012 can be used with or in place of voltage divider resistors 4002, 4004, bipolar junction transistor (BJT) 4006, resistor 4010 wherein the decrease in the BJT emitter-base voltage of approximately—2 mV/C is used to reduce the voltage at the inverting pin of comparator 4026. Voltage divider resistors 4002, 4004 and transistor 4006 connect resistor 4010 in parallel with optional thermistor 4012 when the supply voltage (e.g., 15V) at node 4000 based on the ballast output is at the desired level, creating an over-temperature reference voltage across resistor and thermistor 4012 that is temperature dependent. A reference voltage for the over-voltage protection is provided in parallel using, for example, resistor 4014 and Zener diode 4016 that act as a reference set point which could also be filtered by, for example, capacitor 4018. The reference voltage for the over-voltage protection, modified by the over-temperature circuit, is fed to the non-inverting terminal of a comparator 4026 (or similar function such as an op amp).

The over-voltage and over-temperature reference set point is compared in comparator 4026 with, for example, a voltage, scaled in voltage divider 4022, 4024, at node 4020, which is the voltage used to drive the LED or OLED or QD load (e.g., node 2052, FIG. 20). The scaled voltage is fed to the non-inverting input of the comparator/op amp 4026. Gain/hysteresis setting resistors 4030, 4032 can be used with the comparator 4026. When the thermistor 4012 gets hot, its resistance decreases, lowering the over-voltage and over-temperature reference set point, which would turn on the comparator 4026 and allow current to flow to shutdown signal 4036. When BJT 4006 gets hot, the base to emitter voltage drops and the collector conducts more current eventually turning on BJT 4006 stronger as the temperature increases and reducing the voltage at the inverting input of comparator 4026.

When the scaled voltage is higher than the reference set point signal either because of an over-voltage condition at node 4020 or because of an over-temperature condition lowering the reference set point signal, the comparator 4026 goes high, powering the shutdown signal 4036. Shutdown signal 4036 can also be used to drive an optocoupler to short the drain to source of transistor 2022 of FIG. 20, or of transistor 2430 of FIG. 24, or of transistor 2576 of FIG. 25, or of transistor 2676 of FIG. 26, etc.

In some embodiments, over-voltage protection is provided by a Zener diode 4040 and resistor 4042, transistor 4044 and resistor 4046. If the voltage at node 4000 rises too high, the Zener diode 4040 breaks down and turns on transistor 4042, turning on transistor 4050, which turns off the shutdown signal 4036 and any optocoupler driven by the shutdown signal 4036.

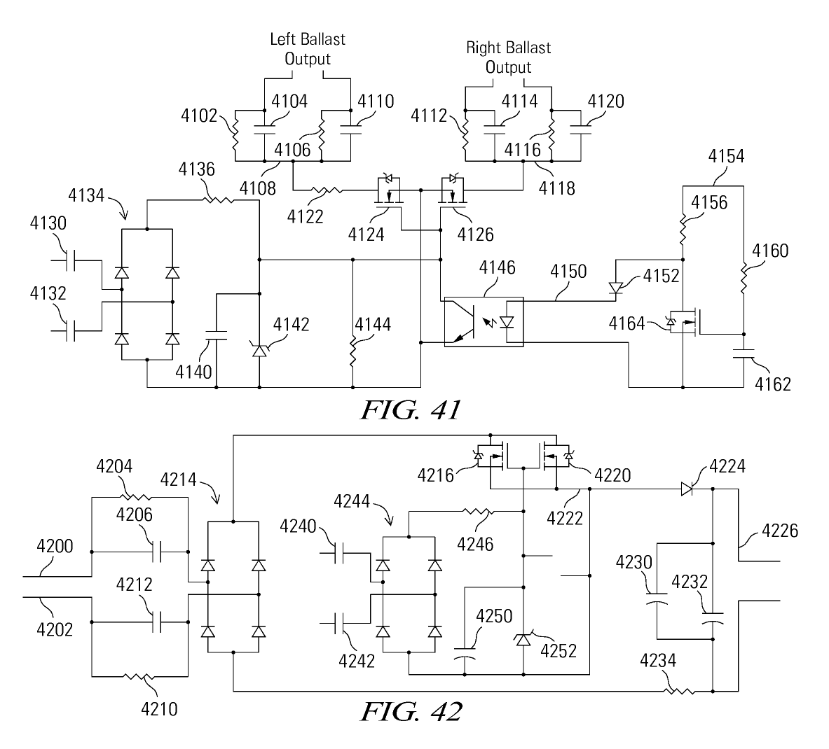

Turning to FIG. 41, an example ballast shorting circuit is depicted that can be controlled by an over-voltage, over-current, and/or over-temperature or other fault detection circuit in a fluorescent lamp LED replacement. Capacitors 4104, 4110 are connected to the left ballast output, with optional resistors 4102, 4106 in parallel with capacitors 4104, 4110, with a common AC node 4108 between them. Capacitors 4114, 4120 are connected to the right ballast output, with optional resistors 4112, 4116 in parallel with capacitors 4114, 4120, with a common AC node 4118 between them.

A resistor 4122 and a common-source MOSFET pair 4124, 4126 are connected between AC nodes 4108, 4118. When the common-source MOSFET pair 4124, 4126 is turned on, it shorts AC nodes 4108, 4118, shorting across the ballast output and preventing current from the ballast output from flowing to a load or other circuits in the fluorescent lamp replacement.

The common-source MOSFET pair 4124, 4126 is powered by a circuit connected across the common source and the gates of the common-source MOSFET pair 4124, 4126. In some embodiments, this power circuit includes capacitors 4130, 4132 connected to the AC nodes 4108, 4118, followed by a diode bridge 4134, voltage reference circuit including resistor 4136, capacitor 4140, and Zener diode 4142, and voltage divider resistor 4144 that limits or drops the gate voltage.

An optocoupler 4146 is connected across the common source and the gates of the common-source MOSFET pair 4124, 4126. When the optocoupler 4146 is turned on, it shorts out the common source and gates, turning off common-source MOSFET pair 4124, 4126 and disabling the shorting function of common-source MOSFET pair 4124, 4126. Thus, current is allowed to flow to the load and other circuits in the fluorescent lamp replacement when the optocoupler 4146 is turned on. The optocoupler 4146 can be powered by any suitable circuit, such as, for example, resistors 4156, 4160, capacitor 4162, transistor 4164 and diode 4152, which draws power from Vdd_15 node 4154.

In the absence of faults such as over-voltage, over-current, or over-temperature, the optocoupler 4146 is turned on to disable the shorting of the ballast by common-source MOSFET pair 4124, 4126. Such faults can be detected, for example, by the circuits of FIG. 21, 23, 29 or 30, with their output signals connected to node 4150 to turn off the optocoupler 4146 during fault conditions, allowing common-source MOSFET pair 4124, 4126 to conduct and short across the ballast.

Turning now to FIG. 42, an example embodiment of a fluorescent lamp LED replacement is depicted with a common-gate, common-drain and common-source MOSFET pair for shock hazard protection. The fluorescent lamp LED replacement draws power from a ballast through capacitors 4206, 4212 with optional resistors 4204, 4210, which can be connected, for example, to the AC nodes 4108, 4118 of FIG. 41. A diode bridge 4214 rectifies the AC signal. Such a power connection and diode bridge can be repeated in parallel and/or series as desired to meet power handling requirements.

A common-gate, common-drain and common-source MOSFET pair 4216, 4220 selectively allows current to flow from the power input and diode bridge 4214, through a diode 4224 to a load output 4226 and parallel capacitors 4230, 4232. One or more current sense resistors 4234 can be connected in series to allow measurement of the load current. When the MOSFET pair 4216, 4220 is turned on, current is allowed to flow to the load output 4226 from the ballast output. During fault conditions, such as when the pins of the fluorescent lamp replacement contact an abnormal ground, the MOSFET pair 4216, 4220 can be turned off by shorting the common gate and common source, blocking current from the ballast output to the load output 4226. Diode 4224 prevents capacitors 4230, 4232 from being shorted and drained during such fault conditions.

The MOSFET pair 4216, 4220 is powered, for example, from AC nodes 4108, 4118, FIG. 41, by a power supply circuit as shown in FIG. 42 including capacitors 4240, 4242, diode bridge 4244, resistor 4246, capacitor 4250 and Zener diode 4252.

As disclosed above, shock hazard/pin safety protection transistors such as, but not limited to, transistor 2202, FIG. 20, or transistor 2430, FIG. 24, or transistor 2576, FIG. 25-26, or MOSFET pair 4216, 4220, FIG. 42, can be turned off using electronic circuits to short the gate to source voltage, and/or by mechanical switches that turn off the shock hazard/pin safety protection transistors when external pins of the fluorescent lamp replacement are exposed.

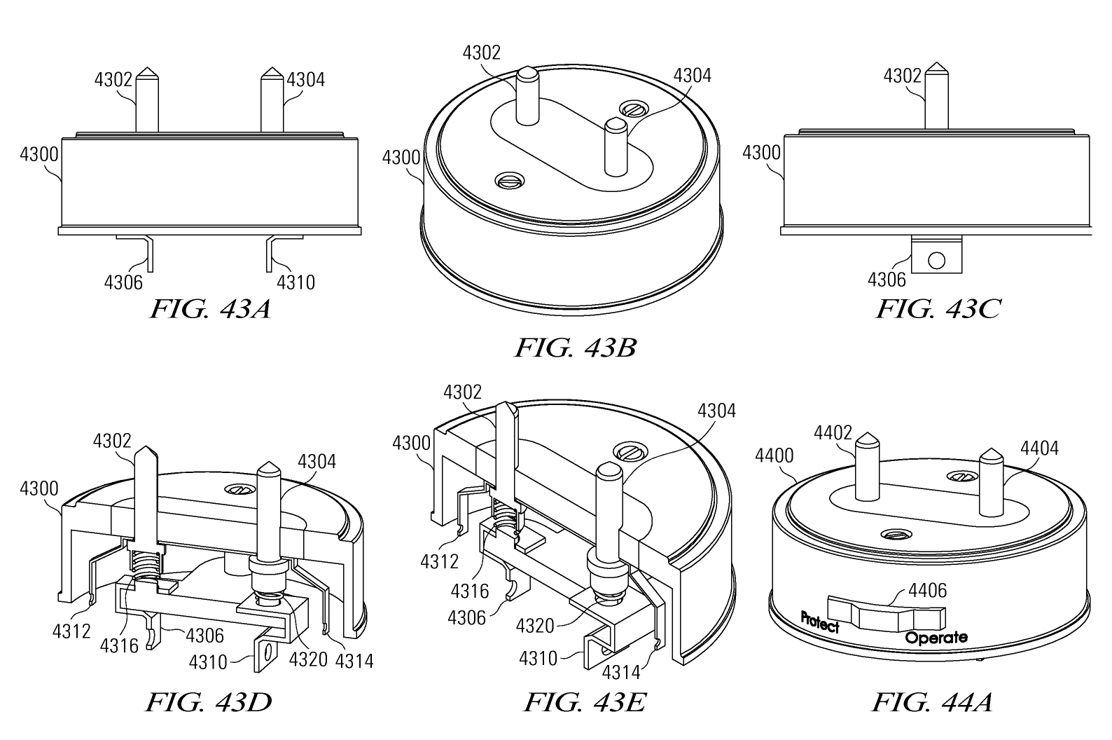

Turning to FIGS. 43A-43E, an end cap 4300 for a fluorescent lamp LED replacement is depicted with spring-mounted pins 4302, 4304 for shock hazard protection. The pins 4302, 4304 are always electrically connected with main tabs 4306, 4310. The ballast output connections referred to in various circuits disclosed herein are connected to main tabs 4306, 4310, such as, for example, capacitors 4104, 4110, 4114, 4120 of FIG. 41.

Shock hazard protection tabs 4312, 4314 are floating and disconnected from pins 4302, 4304 when the pins 4302, 4304 the pins are pressed slightly into the end cap 4300 against the springs 4316, 4320, such as when the fluorescent lamp replacement is correctly installed in a fluorescent lamp fixture. When the pins 4302, 4304 are exposed, the springs 4316, 4320 push the pins 4302, 4304 into a fully extended position, where they contact tabs 4312, 4314. This connection between the pins 4302, 4304, tabs 4312, 4314 and main tabs 4306, 4310 when the pins 4302, 4304 are exposed can be used to short across the gate and source of shock hazard/pin safety protection transistors such as, but not limited to, transistor 2202, FIG. 20, or transistor 2430, FIG. 24, or transistor 2576, FIG. 25-26, or MOSFET pair 4216, 4220, FIG. 42, or across the corresponding Zener diodes used to power those transistors.

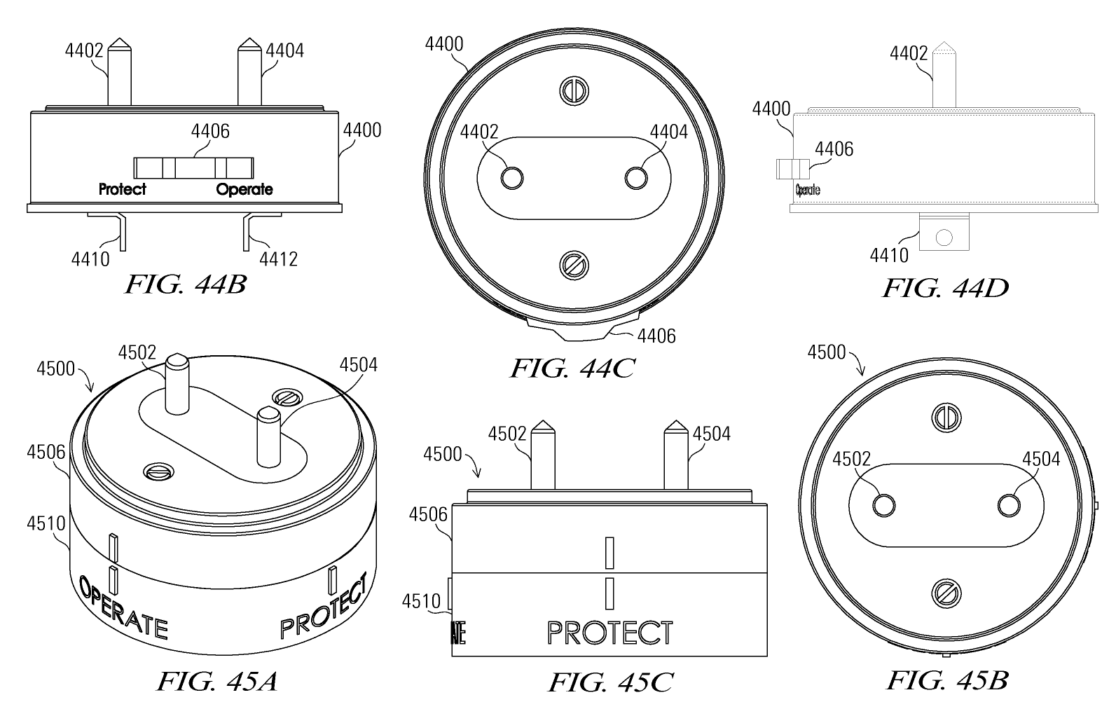

Turning to FIGS. 44A-44D, an end cap 4400 for a fluorescent lamp LED replacement is depicted with slide-switch activated pins 4402, 4404 with shock hazard protection. In this embodiment, a mechanical switch 4406 is included in the end cap 4400, which is set to Protect until the fluorescent lamp replacement is correctly installed in a fixture. The Protect setting closes the mechanical switch, for example shorting across the gate and source of shock hazard/pin safety protection transistors such as, but not limited to, transistor 2202, FIG. 20, or transistor 2430, FIG. 24, or transistor 2576, FIG. 25-26, or MOSFET pair 4216, 4220, FIG. 42, or across the corresponding Zener diodes used to power those transistors. When the fluorescent lamp replacement is correctly installed in a fixture, the mechanical switch 4406 is set to Operate, opening the mechanical switch 4406 and allowing shock hazard/pin safety protection transistors such as, but not limited to, transistor 2202, FIG. 20, or transistor 2430, FIG. 24, or transistor 2576, FIG. 25-26, or MOSFET pair 4216, 4220, FIG. 42, to conduct.

Turning to FIGS. 45A-45C, a rotating end cap 4500 for a fluorescent lamp LED replacement is depicted with rotation-activated pins 4502, 4504 with shock hazard protection. In this embodiment, a mechanical switch is included in the end cap 4400 and is actuated by rotating a cuff 4506 on the end cap 4500 in relation to a fixed cuff 4510 (or vice versa). The rotating cuff 4506 is set to Protect until the fluorescent lamp replacement is correctly installed in a fixture. The Protect setting closes the mechanical switch, for example shorting across the gate and source of shock hazard/pin safety protection transistors such as, but not limited to, transistor 2202, FIG. 20, or transistor 2430, FIG. 24, or transistor 2576, FIG. 25-26, or MOSFET pair 4216, 4220, FIG. 42, or across the corresponding Zener diodes used to power those transistors. When the fluorescent lamp replacement is correctly installed in a fixture, the rotating cuff 4506 is set to Operate, opening the mechanical switch 4406 and allowing shock hazard/pin safety protection transistors such as, but not limited to, transistor 2202, FIG. 20, or transistor 2430, FIG. 24, or transistor 2576, FIG. 25-26, or MOSFET pair 4216, 4220, FIG. 42, to conduct.

The present invention supports all forms and types of dimming of the FLR including by wired and wireless methods for example, but not limited to, controlling the set point/reference for the current or voltage of the FLR. Radio frequency identification (RFID) and similar such systems can be used with the present invention to turn on or off or dim embodiments and implementations of the present invention remotely, voice commands and voice recognition, sound, motion, gesturing, speaking, etc.

The present invention provides protection against damage and injury to the driver and LED array and damage and injury to the user, installer, other personnel and humans in general

The switches including the transistor switches may consist of transistors in series or in parallel or both to electrically inhibit/disrupt/break the path/etc. of the ballast current.

In some embodiments of the present invention, one or more mechanical switches which could be in forms including, but not limited to, a push-button or momentary switch(es) or on-off switch that, for example, when depressed makes contact and completes the circuit may be used with the present invention. The switch can either hold off/disrupt/block/etc. the output voltage of the ballast or be used in conjunction with one or more electronic devices to hold off/block/disrupt the path of electrical conduction from the ballast output to, for example, to the FLR including to ground in the case of a fault or hazard condition or situation. Embodiments of the present invention can use low voltage switches including, but not limited to, mechanical low voltage switches that typically have no more than 15 to 20 volts potential/voltage difference across the switch contacts to complete, for example, the gate drive to FET or IGBT, etc., including, but not limited to, MOSFETs, JFETs, depletion mode FETs, enhancement mode FETs, MESFETs, HEMTs, MODFETs, GaNFETs, SiCFETs, etc.

With many common electronic ballasts, including instant start, rapid start, programmed start, programmable start, pre-start, dimmable including wall, triac, wired, wireless, powerline control ballasts, etc., the current typically may be greater than 100 mA and equal to or less than 200 mA with a value typically in the range of 130 mA to 160 mA or slightly less or slightly greater than these values results in uniform performance for most ballasts except for ballasts designed with, for example, a low ballast factor specifically designed to require and supply lower output power to a florescent tube thereby requiring less power and saving energy. In some embodiments which, for example, do not directly shunt the current, the LED or OLED or QD current can be higher, for example in the range of 200 mA to 400 mA or higher for example with inductor (and/or inductor with one or more tag-along winding(s) or transformers, etc.), diode, capacitor circuits such as, but not limited to, buck, buck-boost, boost-buck, boost, fly back, forward converters, push pull, etc.

Warning of a danger/hazard condition to exist may include a warning light or sound or other means of warning/alerting of such a potential condition/situation. Such a warning may be optional.

Heater emulators could include incandescent light bulbs, lamps, MEMS resistors, bridges, heaters, filaments, thermostructures, thermocouples, capacitors, resistors, other passive components, inductors, any types of combinations of these, etc.

Dimming can be accomplished for any type of control including pulsing including but not limited to duty cycle variation, frequency variation, PWM, burp, hiccup, voltage controlled/referenced, etc. in either a shunt or series or combination by, for example, changing the set point that controls, limits, sets, etc. the current or voltage for the florescent tube replacement to the LEDs or OLEDs or QDs. Such control could be, for example, a smaller or larger voltage. Such emulation circuits could also consist of, for example, capacitors and resistors, for example, as shown in FIGS. 25, 26 for both rapid and instant-start, programmed start, programmable start, dimmable, pre-start and other types of ballasts. Such circuits could have symmetrical or asymmetrical components and component values. Low pass and or high pass circuit can also be used including for frequency detection/sensing, measuring, etc.

The series switch for hazard/leakage current protection can also be used to turn off the ballast mode of an universal and ballast mode FLR that can accept, for example, both AC line and electronic ballast output to power the light source/load such as LEDs and OLEDs and quantum dot (QD)-based light sources.

In some of the particular embodiments, a FET is utilized, however the present invention is not limited to the use of a FET or FETs and other types of switches such as, but not limited to, bipolar junction transistors (BJTs) including all types of BJTs such as npn and pnp, npn Darlingtons and pnp Darlingtons, n-channel or p-channel junction FETs (JFETs), insulated gate bipolar transistors (IGBTs), all types of MOSFETs including p-channel and n-channel MOSFETs, NFETs, unijunction transistors, etc. made from any type of materials including semiconductors such as silicon, silicon carbide, gallium arsenide, gallium nitride, silicon germanium, indium phosphide, gallium aluminum arsenide, gallium aluminum nitride, etc.

Note, additional diodes or bridges as illustrated and depicted in the figures may be used in any of the embodiments depicted in the remaining figures and previous figures.

For example a simple example embodiment of the present invention could include a high frequency diode bridge (or bridges) and a shunt regulator along with protection switch(es) and circuitry. Dithering of, for example, but not limited to, frequency, duty cycle, width, etc. may be used with the example embodiments shown herein and in general for the present invention to, for, example, but not limited to, to provide EMI dithering and reduction.

Another example embodiment of a fluorescent lamp LED replacement with a high frequency diode bridge (or bridges), a shunt regulator and current feedback along with protection switch(es) and circuitry.

An example embodiment of the present invention includes a fluorescent lamp LED (or OLED or QD) replacement with a high frequency diode bridge (or bridges), a shunt regulator and current feedback and additional over-protection and current control feedback.

The present invention can also be used with example embodiments of a fluorescent lamp LED replacement that can operate and receive power either from a ballast or from the AC line voltage with a high frequency diode bridge (or bridges) and a current to voltage converter that can be switched to operate a LED driver should a ballast be used with the present invention or used with AC input voltage applied to the fluorescent fixture terminals.

The present invention can also be used with example embodiments of a fluorescent lamp LED replacement with a high frequency diode bridge (or bridges) and a current to current transformer (or transformation) with a shunt regulator and associated feedback and control to set the current of a LED or OLED, or QD or combinations of these output load.

The present invention can also be used with example embodiment of a fluorescent lamp LED replacement with a high frequency diode bridge (or bridges) and a current to current transformer (or transformation) that feeds a rectification stage with a shunt regulator and associated feedback and control to set the current of a LED or OLED, or QD or combinations of these output load where the feedback and control information is fed back to the shunt regulator.

The present invention can also be used with an example embodiment of a fluorescent lamp LED replacement with a high frequency diode bridge (or bridges) and a current to current transformer (or transformation) with a shunt regulator and associated feedback and control to set the current of a LED or OLED, or QD or combinations of these output load where the feedback and control information is also fed back to the current to current transformation stage and the rectification stage.

The present invention can also be used with an example embodiment of a fluorescent lamp LED replacement with a high frequency diode bridge (or bridges) and a current to current transformer (or transformation) with a shunt regulator and associated feedback and control to set the current of a LED output load where the feedback and control information is also fed back to the current to current transformation stage and the shunt regulator.

The present invention can also be used with an example embodiment of a fluorescent lamp LED replacement with a high frequency diode bridge (or bridges) and a current to current transformer (or transformation) having protection and detection with a shunt regulator and associated feedback and control to set the current of a LED output load where the feedback and control information is also fed back to the current to current transformation stage and the shunt regulator.

The present invention can also be used with an example embodiment of a fluorescent lamp LED replacement with a high frequency diode bridge (or bridges) and a current to current transformer (or transformation) having protection and detection with a shunt regulator and associated feedback and control to set the current of a LED output load where the feedback and control information is also fed back to the current to current transformation stage and the shunt regulator as well as from the protection and detection stage. Feedback, protection response, etc. can come from and go to one or more of the stages. Features, functions, circuits, operations, etc. discussed and shown herein can also be performed using microcontrollers, microprocessors, DSPs, FPGAs, etc.

The present invention can also be used with an example embodiment of a ballast driver for a fluorescent lamp LED replacement. High frequency diodes form a high frequency full wave rectification bridge. Additional diodes or bridges may be included as needed or desired. The shunt transistor acts as a shunt switch to shunt current from the ballast as needed or required for a particular application and also serves as a protection against over-current including over-current transients. An additional diode prevents the shorting of the load (LEDs) when the transistor is turned on and shorts (shunts) the ballast.

The present invention can also be used with an example embodiment of a ballast driver for a fluorescent lamp LED replacement. High frequency diodes form a high frequency full wave rectification bridge. Additional diodes or bridges may be included as needed or desired. A transistor or transistors acts as a shunt switch to shunt current from the ballast as needed or required for a particular application and also serves as a protection against over-current including over-current transients. An additional diode prevents the shorting of the load (LEDs and/or OLEDs and/or QDs) when the transistor is turned on and shorts (shunts) the ballast. Optional capacitance may be added and may consist of one or more capacitors. An optional resistor acts as a current sense and could be replaced with any other type of current sense element including but not limited to current sense transformers, current transformers, sense transistors, etc.

Optional capacitance may be added and may consist of one or more capacitors as well as adding an optional inductor and/or an optional sense element which could be a resistor that acts as a current sense or could be any type of current sense element including but not limited to current sense transformers, current transformers, sense transistors, etc.

The present invention can also be used with an example embodiment of a ballast driver for a fluorescent lamp LED replacement. High frequency diodes form a high frequency full wave rectification bridge. Additional diodes or bridges may be included as needed or desired. Capacitors attached to the input of the high frequency bridge act as a current limiter and also present high impedance elements at low frequencies including, for example, at or around 50 or 60 Hz and limit the current that can be passed to the high frequency bridge and the rest of the circuit/driver of the FLR so as to protect the circuit from high voltage AC inputs. A shunt switch can be used to shunt current from the ballast as needed or required for a particular application and also serves as a protection against over-current including over-current transients. A diode prevents the shorting of the load (LEDs) when the switch is turned on and shorts (shunts) the ballast by, for example, a Controller, which for the present invention can be used to both regulate and control the protection. Optional capacitance may be added and may consist of one or more capacitors. One or more optional sense elements which could be resistors act as current sense(s) and could also be any type of current sense element including but not limited to current sense transformers, current transformers, sense transistors, etc. Any type of switch, transistor, vacuum tube, semiconductor device, etc. may be used. A resistor and Zener diode may provide a voltage limit protection. Additional elements including but not limited to additional diodes may be added/incorporated/etc. and may also include/incorporate any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to detect frequency including low-pass, high-pass, band-pass, notch filters of any order. Audio detectors, frequency to voltage converters, tone detectors, any form and type of frequency detection, etc. and combinations of these may be used. In other embodiments, circuits that can be either powered or not powered, as the case may be, can be used to enable either ballast circuits or AC line circuits. In addition, voltage and/or current detect circuits may be used in place of or to augment the frequency detect circuit. The frequency detect circuit can detect and discriminate low frequency (i.e., 47 to 63 Hz, 400 Hz) AC input line frequencies from, for example, kHz (i.e., typically above 32 kHz and often above 40 kHz electronic ballast output frequencies).

The present invention can also be used with an example embodiment of a ballast and universal AC input driver for a fluorescent lamp LED replacement. Additional diodes or bridges may be included as needed or desired. Inductors along with capacitors can be used as an EMI filter which could also include chokes, resistors, other capacitors, inductors, etc. and other arrangements, implementations, etc. Other EMI filters could be used as needed on other parts of the input or output. An inductor, transistor and a diode can form, for example, a buck or buck-boost converter. Although a buck-boost is mentioned, any type of converter, including, but not limited to, buck, boost, boost-buck, Cuk, SEPIC, flyback, forward-converter, fly-back converter, etc. may be used. High frequency diodes or synchronous transistors can be used to form a high frequency full wave rectification bridge. Capacitors at the input of the high frequency full wave rectification bridge provide both current limiting to the FLR and also act as high impedance elements at low frequencies including, for example, at or around 50 or 60 Hz and limit the current that can be passed to the high frequency bridge and the rest of the circuit/driver even for AC input voltages typically up to 480 VAC and higher if necessary. A transistor can act as a shunt switch to shunt current from the ballast as needed or required for a particular application and also serves as a protection against over-current including over-current transients. A diode prevents the shorting of the load (LEDs or OLEDs or QDs or combinations of these) when either the shunt control transistor or a second over voltage protection shunt transistor is turned on and shorts (shunts) the ballast. Optional capacitance may be added and may consist of one or more capacitors along with optional resistors in parallel or series or both and, in some embodiments, inductors. Optional sense elements which could be resistors that act as a current sensor or could also be any type of current sense element including but not limited to current sense transformers, current transformers, sense transistors, etc. may also be added. Capacitors and diodes and other elements may be used to form a circuit such that an appreciable and useful voltage is developed, for example, across a resistor and capacitor in parallel with an optional protection device or devices such as a Zener diode to drive and turn on a transistor when the input can provide a high enough drive (i.e., kHz) and has little voltage insufficient to drive and turn on a transistor for frequencies, for example, in the range of 47 to 63 Hz or, also for example, 400 Hz. Although a MOSFET is typically used for the transistor, any type of switch, transistor, vacuum tube, semiconductor device, etc. may be used. Again a Zener diode along with other components can provide, for example, voltage limit protection and also in certain embodiments current limiting. Other transistors may be used in the ballast mode to, for example, provide the return path for the ballast mode if needed. Additional elements including but not limited to additional diodes or other elements including but not limited to resistors, capacitors and/or inductors may be added/incorporated/etc. into the circuitry. The circuit may be any type of circuit, and may contain, for example, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to detect frequency including low-pass, high-pass, band-pass, notch filters of any order. In addition, voltage and/or current detect circuits may be used in place of or to augment the frequency detect circuit. The frequency detect circuit can detect and discriminate low frequency (i.e., 47 to 63 Hz, 400 Hz) AC input line frequencies from, for example, kHz (i.e., typically above the audio frequencies and usually above 32 kHz and often above 40 kHz electronic ballast output frequencies).

The present invention can also be used with an example embodiment of a fluorescent lamp LED replacement that accepts either an AC lines input or a ballast output including magnetic (normally low frequency) and electronic (normally high frequency) and supplies a constant current (or constant voltage) to the load (which typically is a LED or OLED array) with the switch(es) set for boost-buck mode with ballast detect and switches, a high frequency diode bridge (or bridges) and a boost-buck (which could also be a buck, boost, buck-boost, Cuk, SEPIC, flyback, forward-converter, etc.) of any type, architecture, topology, etc. including, but not limited to, discontinuous conduction mode (DCM), continuous conduction mode (CCM), critical conduction mode (CRM), resonant conduction mode (RCM), synchronous, etc., a ballast accept circuit including those illustrated in the previous figures, and a load (i.e., LED or OLED). This example embodiment could also include items such as a current to current transformer (or transformation) having protection and detection with a shunt regulator and associated feedback and control to set the current of a LED output load where the feedback and control information is also fed back to other parts of the driver.

While illustrative embodiments have been described in detail herein, it is to be understood that the concepts disclosed herein may be otherwise variously embodied and employed. In addition, the present invention is applicable to both non-isolated and isolated circuits, including, buck, boost, buck-boost, boost-buck, cuk, fly-back, forward transformers, etc. in, for example, but not limited to, continuous conduction, critical conduction, discontinuous conduction, etc. including resonant approaches, topologies and designs. The present invention can be used in replacement lamps including linear replacement lamps that are designed to provide cool white, bright white, warm white, soft white, etc. (i.e., color ranges that typically span from less than 2700 Kelvin to greater than 6500 Kelvin color temperature with appropriate color rendering index (CRI) and other such optical desired optical performance and perception, etc. The present invention may also be used with multi-color LEDs and organic LEDs (OLEDs) including but not limited to red-green-blue (RGB) LEDs with or without white LEDs, etc. Nothing in this document should be viewed as limiting in any way or form the present invention as applied to protection for LED replacement lamps for fluorescent lamps. For example, some embodiments of the present invention may use color changing, color tunable, color changing with or without white light, color rendering, etc. lighting including red blue green (RGB) with or without white LEDs, OLEDs, QDs or other light sources that can be controlled, tuned, monitored, adjusted, changed, set, etc. using, for example, but not limited to, wireless, wired, powerline control, etc. where the wireless can be, but is not limited to radio frequency (RF) such as WiFi, ZigBee, IEEE 801, ISM bands, and any frequency and/or standard from less than 1 MHz to greater than 1 THz, etc. In addition analytics including input and output power, current, voltage, power factor, color settings, color rendering, temperature, color temperature, color adjustment, humidity, signal strength, etc. The present invention can also be used in conjunction with dimmers of all types and forms including but not limited to solar dimmers as described in U.S. patent application Ser. No. 13/795,149 for a “Solar Powered Portable Control Panel”, filed Mar. 12, 2013, which is incorporated herein by reference for all purposes.

The present invention may also be powered directly from, for example, 100 to 300 VAC 50 Hz or 60 Hz AC line input using any two input wires and, in general, powered from 100 to 277 VAC or higher voltage with a magnetic ballast using, for example, in some embodiments all 4 wires.

With embodiments of the present invention, the starter will automatically be left unpowered using the present invention by the additional two wires thus the removal of the starter is now unnecessary and optional. Should there be a power factor (PF) capacitor (if applicable) it is now rendered unnecessary with the present invention which can have a very high power factor and the capacitor may, under certain circumstances, actually lower power factor. However the phase and power factor of the present invention can be adjusted as needed. Removal of the capacitor would typically be recommended, but is optional. Any fixture with a magnetic ballast may be left completely unmodified so that either a fluorescent or the present invention may be used interchangeably in such a fixture with a magnetic ballast. In other embodiments of the present invention, where the embodiment(s) is/are only designed for electronic ballasts, the present invention can protect against inadvertent ‘plugging in’ to AC lines or magnetic ballasts in a number of ways and methods including the use of current limiting devices and components such as capacitors which can also serve as current/voltage limiting elements to protect electronic only FLRs. In dimming applications, the protection detection/monitoring/control/etc. can interact and know about the dimming requests, level and/or other parameters and adjust and respond accordingly. In one embodiment of the present invention, dimming can only be effected and accomplished after the FRL is safely put into operation so as to offer full protection during the installation process against injuries, harm and fatalities to the installing person or personnel. Such a feature can be made to be automatic each time the lamp is disconnected/reconnected/installed/etc.

The present invention supports power factor correction (PFC) especially for the universal AC input mode. The present invention in various embodiments supports all types of dimming including, but not limited, Triac, other types of forward and reverse phase dimming, 0 to 10 V dimming, other remote control, dimming and monitoring including powerline, wired and wireless control, etc. and also allows and supports analytics including data logging of any and all input and output parameters and values including but not limited to power factor, input and output voltage and current, efficiency, VAR, input and output power, input and output real power, etc.

In some embodiments the same controller can be used for both the series (input voltage controlled mode—IVCM) and shunt (input current controlled mode—ICCM) with, for example, an inversion of the IVCM PWM output for the ICCM. ICCM can be used for constant current control (CCC) implementations and applications.

The present invention can be used with all types of ballasts including instant-on, pre-heat, rapid start, programmed start, etc. Implementations can be with or without heater connections, can use multiple diodes, heater emulation circuits including both passive and active heater emulation circuits that can be analog, digital, or combinations of the analog and digital. Such heater circuits can contain resistors, capacitors, inductors, transformers, transistors, switches, diodes, silicon controlled rectifiers (SCR), triacs, other types of semiconductors and ICs including but not limited to op amps, comparators, timers, counters, microcontroller(s), microprocessors, DSPs, FPGAs, ASICs, CLDs, AND, NOR, Inverters and other types of Boolean logic digital components, combinations of the above, etc.

EMI filters can be included as needed to comply with regulatory and safety agencies. For example, an EMI filter may be required for AC line operation mode or for the ballast operation mode. Such filters can be switched in or out as needed as part of the present invention and can include one or more of the following capacitor, resistors, diodes, inductors, coupled inductors, transformers, etc. In some embodiments of the present invention, a current shunt can be used to convert the current (I) effectively to a voltage (V). In addition the circuits to perform this conversion can work with typical voltage mode circuits and should also work without issue with a DC input. As discussed above, the I-V circuit can be in some embodiments replaced/bypassed or connected through with the EMI filter for standard AC input operation. This switchover and detection can be accomplished by, for example but not limited to, manual switching, automatic switching, detection and switching, analog or digital switching, remote control, remote sensing and control, remote monitoring and control, by frequency detection/selection, current detection/selection, voltage/detection selection, waveform detection/selection, waveform shape, etc. detection/selection, a combination of the above, etc. In some embodiments of the present invention, the manual or autodetect/select can use conventional, mechanical, solid-state, hybrid relays, SCRs, triacs, transistors including MOSFETs and/or BJTs and other switchable elements. In yet other embodiments, switches, jumpers, cables, matrices, reconfigurable switches and related elements, etc. can be employed. Embodiments of the present invention may include a current limit or limits both for the ballast mode and the AC line mode.

In some embodiments and applications, there may be a need to have a feedback connection from certain parts of the circuit to the I-V section. For example, if the voltage of the I-V output is set too high it may needlessly circulate current, which would lower the efficiency. This can be addressed with proper detection and feedback to ensure high efficiency.

Some embodiments of the present invention essentially act and/or perform as a current to current converter in which the constant current from the ballast is fed to the current converter which then converts the current to desired output with the ballast voltage complying with the current and power requirement so long as it does not exceed the operational maximum voltage/power/performance of the ballast.

In general, the ballast should supply a decent to high quality +/−AC sine wave and, for many electronic ballasts, if the sine wave current is interrupted/stopped, the ballast, especially for electronic ballasts that are considered ‘smart’ and should be able to detect and capable of detecting faults, will try to respond by taking an appropriate action such as, for example, trying to restart the ballast lamp load or shutting down. The present invention is able to faithfully emulate a fluorescent lamp and provide the necessary performance and behavior for the electronic ballast to operate correctly.

The current [input] constant current [output] (CCC) shunt design (i.e., ballast mode) of the present invention works with both ˜20 to greater than 100 kHz (typical 40 kHz to 80 kHz) and 50/60/400 Hz constant current input. Embodiments of the present invention can be both low parts count and high efficiency. Some embodiments may include a sine or square-wave conversion stage. The shunt regulator is quite efficient also. In many embodiments of the present invention, at full LED current, little current goes to the shunt, so then the efficiency is very high. With the voltage [input] constant current [output] (i.e., universal AC input mode), the efficiency can also be very high as well as having a very high to ultra high power factor correction/power factor.

For universal CCC/VCC embodiments, the input terminals can be the same. As illustrated in some of the figures, for some of the embodiments only two blocks are added: a high-frequency bridge rectifier and a Zener including a lossless Zener (shunt regulator).

In some embodiments of the present invention, when in Line (V) mode the shunt is set to control point could be set to, for example, ˜400 V or ˜450 V. When in Ballast (I) mode the shunt is set to a lower voltage, corresponding to the designed power of the LED. For example, if the AC line is under ˜400 V (or ˜450 V) peak, the shunt stays off, so no power or otherwise from the shunt is drawn. This example scheme can also be used with (or without) the frequency detection mode.

In the event that, for example the manual switching was left in the incorrect configuration, the shunt would use some power and possibly produce some EMI, however the driver would still work and function.

In Ballast (I) mode the shunt could be set to, for example, ˜100V. This would draw less idle power from the ballast, and when the LED was at full power the shunt would typically barely be running/on. If the switch was left in the wrong position, the shunt would regulate at 400V, resulting in potentially more power loss (which could be addressed and eliminated with appropriate detection and correction), however the driver would still work and operate properly.

With the present invention, the feedback from the output demand would, in effect, increase the effective resistance/impedance of the converter, thus if the current source went up, the voltage draw would go down thus acting like a negative resistance.

In some embodiments of the present invention, one or more inductors (as well as and/or in addition to capacitors and other passive and active elements) can be used to keep the LED voltage from going to zero when OVP, OCP, OTP shunt transistors are shorted. Such inductor(s) allows for OVP, OCP, OTP shunt transistors to act as a variable current shunt to ground, with low power loss. With capacitance on the output, capacitance can also be placed on the input to cut down on spurious signals including noise and spikes and to also help with and reduce EMI including radiated EMI. In some embodiments of the present invention, an inductor can also be put in series with the MOSFET, and a clamp diode to contain the flyback voltage. In some embodiments of the present invention, inductors can be put on either or both the input and/or output to also provide filtering to reduce the ripple to the load (i.e., LED array). The switching frequency of, for example, OVP, OCP, OTP shunt transistors could typically be in the range of 20 kHz or higher (i.e., typically above the human audio range) or, in the case of overcurrent or overvoltage conditions, possibly lower and even much lower than 20 kHz or higher. For dimming, and for example, when using PWM dimming, the frequency of the PWM dimming can be much lower and typically in the range of ˜100 Hz and higher. For switching and dimming switching, switching can be done on either side of the transformer for embodiments of the present invention depending on considerations that, for example, determine the appropriate placement.

Embodiments of the present invention allow for no, passive and/or active control. Some embodiments of the present invention provide in the matching circuit, for example, a chopper that typically can be switching in a frequency range of less than 20 kHz to greater than 100 kHz, either free running, self-oscillating or controlled, so that the transformer or equivalent current to current transformer and/or converter can be small even with a 60 Hz ballast. In addition, by providing a regulator circuit, can make, for example, the LED independent of the ballast, and therefore universal.

In some embodiments of the present invention, the converter used for the series regulation from the AC lines can also be used for the shunt regulation from the ballast output, with the control inverted from a normal voltage-in/voltage-out converter or voltage-in/current-out operation.

With a ballast, the present some implementations of the present invention utilize current output control with a shunt regulator with switching mode regulation chosen to keep it efficient. In this case, the regulator switches to effective/local ground (low voltage drop equals low power dissipation) or open (no current equals low power dissipation). In addition to the passive and active components mentioned previously, other protection and detection devices and components can be used with the present invention including but not limited to tranzorbs, transient voltage suppressors (TVSs), Varistors, metal oxide varistors (MOVs), surge absorbers, surge arrestors, and other transients detection and protection devices, thermistors or other thermal devices, fuses, resettable fuses, circuit breakers, solid-state circuit breakers and relays, other types of relays including mechanical relays and circuit breakers, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

Programmable soft start including being able to also have a soft short at turn-on which then allows the input voltage to rise to its running and operational level can also be included in various implementations and embodiments of the present invention.

Some embodiments of the present invention utilize high frequency diodes including high frequency diode bridges and/or synchronous transistor rectifier bridges and current to voltage conversion to transform the ballast output into a suitable form so as to be able to work with existing AC line input PFC-LED circuits and drivers. Some other embodiments of the present invention utilize high-frequency diodes and/or synchronous transistor rectifier bridges to transform the AC output of the electronic ballast (or the low frequency AC output of a magnetic ballast into a direct current (DC) format that can be used directly or with further current or voltage regulation to power and driver LEDs for a fluorescent lamp replacement. In some embodiments of the present invention, snubber and/or clamp circuits may be used with the rectification stages (which, for example, could be diodes or transistors operating in a synchronous mode); such snubbers could typically include capacitors, resistors and/or diodes or be of a lossless type of snubber where the energy is recycled or be made of capacitors only or resistors only, etc. Such snubbers can be of benefit in reducing radiated emissions. Some embodiments of the present invention can use lossless snubbers. Embodiments of the present invention can be used to convert the low frequency (i.e., typically 50 or 60 Hz) AC line and/or magnetic ballast AC as well as electronic higher frequency AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, linear regulation, buck, buck-boost, boost buck, boost, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, NPN and/or PNP BJTs including Darlington transistors, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figure and embodiments shown are merely intended to provide some illustrations of the present inventions and not limiting in any way or form for the present inventions.

Using digital and/or analog designs and/or microcontrollers and/or microprocessors any and all practical combinations of control, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for the example embodiments shown here, the maximum will be equal to or approximately equal to the voltage on the negative input of the comparator. In addition wireless control including dimming may be used to, for example, set the reference current setpoint used, for example, to control the current supplied to the LEDs or OLEDs or QDs, etc.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming by, for example, using a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or killowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, other serial interfaces, etc.), a combination of analog and digital, analog-to-digital converters and interfaces, digital-to-analog converters and interfaces, wired, wireless (i.e., RF, WiFi, ZigBee, Zwave, ISM bands, 2.4 GHz, etc.), powerline (PLC) including X-10, Insteon, HomePlug, etc.), etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, touch sensor(s), wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, linear regulators, etc. The present invention works with both isolated and non-isolated designs including, but not limited to, buck, boost-buck, buck-boost, boost, cuk, SEPIC, flyback and forward-converters. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention may also be adapted to provide overvoltage or overcurrent protection, short circuit protection for, for example, a dimming LED or OLED or QD driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design, topology, implementation, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention described above primarily for motion and light/photodetection control, can and may also use other types of stimuli, input, detection, feedback, response, etc. including but not limited to sound, voice, voice control, motion, gesturing, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors), a voice sensor and/or detector, voice recognition, and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both including, but not limited to, Darlington transistors, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus for replacing a fluorescent lamp, comprising:
a plurality of pins configured to electrically connect to a fluorescent lamp fixture;
at least one non-fluorescent light source;
a transistor between at least one of the plurality of pins and the at least one non-fluorescent light source; and
a shock hazard protection circuit configured to disable the transistor to limit current flowing through at least some of the plurality of pins.

2. The apparatus of claim 1, wherein the shock hazard protection circuit comprises a mechanical switch.

3. The apparatus of claim 2, wherein the mechanical switch is normally open.

4. The apparatus of claim 2, wherein the mechanical switch is normally closed.

5. The apparatus of claim 1, wherein the shock hazard protection circuit comprises an under-current detection circuit configured to detect a lower than expected current to the plurality of pins.

6. The apparatus of claim 1, wherein the shock hazard protection circuit comprises an optocoupler connected across a control input of the transistor and another lead of the transistor.

7. The apparatus of claim 1, wherein the shock hazard protection circuit comprises an optocoupler connected across a gate and a source of the transistor.

8. The apparatus of claim 1, further comprising a ballast short circuit connected across the plurality of pins, and a fault detection circuit configured to control the ballast short circuit.

9. The apparatus of claim 8, wherein the fault detection circuit comprises an over-voltage detection circuit.

10. The apparatus of claim 8, wherein the fault detection circuit comprises an over-current detection circuit.

11. The apparatus of claim 8, wherein the fault detection circuit comprises an over-temperature detection circuit.

12. The apparatus of claim 8, wherein the fault detection circuit is configured to short an AC current across the plurality of pins.

13. The apparatus of claim 8, further comprising a diode connected between the transistor and the at least one non-fluorescent light source, wherein the fault detection circuit is configured to short a DC current between the transistor and the at least one non-fluorescent light source.

14. The apparatus of claim 13, further comprising at least one capacitor connected in parallel with the at least one non-fluorescent light source downstream from the diode.

15. The apparatus of claim 1, wherein the transistor comprises a common-gate, common-source, common-drain MOSFET pair.

16. The apparatus of claim 1, further comprising a constant-current regulation circuit.

17. The apparatus of claim 16, further comprising a processor having a remote control interface.

18. The apparatus of claim 17, wherein the processor is configured to transmit status information through the remote control interface.

19. The apparatus of claim 17, wherein the processor is configured to receive dimming commands through the remote control interface and to control the constant-current regulation circuit based at least in part on the dimming commands.

20. The apparatus of claim 17, wherein the shock hazard protection circuit is implemented at least in part by the processor.
